(19) United States
(12) Patent Application Publication
(10) Pub. No.: US 2008/0267423 A1
(43) Pub. Date: Oct. 30, 2008

(54) Object sound extraction apparatus and object sound extraction method

(75) Inventors: Takashi Hiekata, Kobe-shi (JP); Takashi Morita, Kobe-shi (JP); Yohei Ikeda, Kobe-shi (JP); Toshiaki Shimoda, Kobe-shi (JP)

Correspondence Address: REED SMITH LLP, 3110 FAIRVIEW PARK DRIVE, SUITE 1400, FALLS CHURCH, VA, 22042, US

(73) Assignee: Kabushiki Kaisha Kobe Seiko Sho

(21) Appl. No.: 12/078,839

(22) Filed: Apr. 7, 2008

(30) Foreign Application Priority Data
Apr. 26, 2007 (JP) 2007-116519
Apr. 26, 2007 (JP) 2007-116704
Apr. 26, 2007 (JP) 2007-116723
Dec. 17, 2007 (JP) 2007-325036
Dec. 17, 2007 (JP) 2007-325065
Dec. 17, 2007 (JP) 2007-325101

(51) Int. Cl. H04R 3/00

(52) U.S. Cl. 381/92

(57) ABSTRACT

An object sound extraction apparatus includes sound source separation sections for separating and generating an object sound separation signal corresponding to an object sound and reference sound separation signals corresponding to the other reference sound based on each combination of a main acoustic signal and sub acoustic signals, an object sound separation signal synthesis section for synthesizing the object sound separation signals, and a spectrum subtraction processing section for extracting an acoustic signal corresponding to the object sound from the synthesis signal by performing a spectrum subtraction processing between the synthesis signal and the reference sound separation signals. Accordingly, in acoustic environments where the object sound and the noises are mixed in the acoustic signals obtained via the microphones, and the mixed conditions can vary, a high object sound extraction performance can be ensured by a small object sound extraction apparatus.

### BACKGROUND OF THE INVENTION

1. Field of the Invention

The present invention relates to an object sound extraction apparatus and an object sound extraction method for extracting an acoustic signal corresponding to an object sound from a predetermined object sound source based on acoustic signals obtained via microphones, and outputting the extracted acoustic signal.

2. Description of the Related Art

In devices that have a function to input sound generated by sound sources, such as audio conference systems, video conference systems, ticket-vending machines, car navigation systems, and speakers, a sound (hereinafter, referred to as object sound) generated by a certain sound source (hereinafter, referred to as object sound source) is collected by voice input means (hereinafter, referred to as microphone). Depending on environments the sound source exists, in an acoustic signal obtained via the microphone, noise components other than an acoustic signal component corresponding to the object sound are contained. If a ratio of the noise components in the acoustic signal obtained via the microphone is large, clarity of the object sound is lost, and quality in telephone call and automatic voice recognition rates are decreased.

Conventionally, it has been known a two-input spectrum subtraction processing that uses a main microphone (voice microphone) in which a voice (an example of the object sound) generated by a speaker is mainly inputted, and a sub microphone (noise microphone) in which noises around the speaker are mainly inputted. In the processing, noise signals according to acoustic signals obtained via the sub microphone are removed from acoustic signals obtained via the main microphone. The two-input spectrum subtraction processing extracts (that is, removes the noise components) the acoustic signals corresponding to the voices (the object sounds) generated by the speaker using a subtraction processing of time-series characteristic vectors of each inputted signal from the main microphone and the sub microphone.

For the sub microphone, to prevent the object sound from being mixed in as much as possible, a microphone that is disposed at a position different from that of the main microphone or a microphone that has directivity different from that of the main microphone is employed. Accordingly, if different noises reach to each microphone from a plurality of directions, noises collected by the sub microphone and noises being mixed in the mail microphone may differ from each other. In such a case, the noise-removing performance in the two-input spectrum subtraction processing is decreased.

Meanwhile, it has been known a noise removing device that uses a plurality of sub microphones (noise microphones). In the device, the two-input spectrum subtraction processing is performed with respect to acoustic signals inputted via each sub microphone based on, depending on situations, an acoustic signal selected from the acoustic signals, or a synthetic signal that is weighted averaged by a predetermined weight, and an acoustic signal inputted via a main microphone. By the noise removing device, even in an acoustic space where nonstationary noise that changes temporal and spatial characteristics is generated, effective noise removal can be performed.

Further, in addition to the above known technologies, it has been known a camcorder that calculates a correlation coefficient of a plurality of sound signals of sounds that are collected from a plurality of directions in a shooting area, and based on the correlation coefficient, emphasizes a sound signal generated from a person existing in a direction of a center of the shooting area.

Further, it has been known a technology that obtains an extraction signal of an object sound by removing a signal that is generated by processing an acoustic signal obtained via a microphone (corresponding to the above sub microphones) that mainly inputs reference sounds (non-object sounds) other than an object sound using an adaptive filter from an acoustic signal (hereinafter, referred to as main acoustic signal) obtained via a microphone (corresponding to the above main microphones) that mainly inputs an object sound, and adjusts the adaptive filter so that the power of the extraction signal is minimized.

Meanwhile, in a case where a plurality of sound sources and a plurality of microphones (acoustic input means) exist in a predetermined acoustic space, in each of the microphones, an acoustic signal (hereinafter, referred to as mixed acoustic signal) in which individual acoustic signals (hereinafter, referred to as sound source signals) from each of the sound sources are superimposed is inputted. The method that identifies (separates) each sound source signal based on only the mixed acoustic signals that are inputted as described above is called as blind source separation method (hereinafter, referred to as BSS method).

Further, one of sound source separation processing of the BSS method, there is a sound source separation processing based on an independent component analysis (hereinafter, referred to as ICA). In the BSS method based on the ICA, by using the fact that each of the sound source signals are statistically independent each other in the mixed acoustic signals inputted via the microphones, a predetermined separation matrix (inverse mixed matrix) is optimized. To the inputted mixed sound signals, filter processing using the optimized separation matrix is performed to identify (separate sound source) the sound source signals. In the processing, the optimization of the separation matrix is performed based on an identified (separated) signal (separated signal) identified by a filter processing using a separation matrix set at a certain time, by calculating a separation matrix which is subsequently used by sequential calculation (learning calculation).

In the sound source separation processing based on the ICA-BASS method, each separated signal is outputted via each output end (also referred to as output channel). The number of the output ends if the same as the number of inputs (the number of microphones) of the mixed acoustic signals.

Further, as the sound source separation processing, a sound source separation processing based on a binary masking processing (an example of binaural signal processing) has been known. The binary masking processing is a sound source separation processing that can be realized at a relatively low operation load performed by comparing levels (power) in each of frequency components (frequency bins) divided in a plurality of components between mixed sound signals inputted via a plurality of directional microphones to remove signal components other than sound signals from main sound sources of each mixed sound signal.

However, in the known arts, if the object sound is mixed in at a relatively large volume, a component of an acoustic signal corresponding to the object sound is considered as a noise component, and mistakenly removed. Accordingly, it is not possible to obtain a high noise removal performance.

Further, if a synthetic signal obtained by weighting and averaging sound signals inputted via sub microphones (noise microphones) by a predetermined weight is used for the input signal in the two-input spectrum subtraction processing, depending on changes in acoustic environments, mismatches between the weight in the weighted average and a degree of mix of the object sound in each of the sub microphones occur, and the noise removal performance is decreased. Further, if the signal selected from the plurality of acoustic signals inputted via the sub microphones (noise microphones) is used for the input signal in the two-input spectrum subtraction processing, under the condition different noises arrive at each microphone from the plurality of directions, noise components based on acoustic signals that are not selected are not removed. Accordingly, the noise removal performance is decreased.

In the above-described technology of the camcorder, the sound signal generated by the person at the center of the shooting area is emphasized. However, the other sound signals remain, and the signal of the object sound is not extracted.

If, based on the main acoustic signal and the sub acoustic signal, the sound source separation processing in the BSS method based on the ICA or the binary masking processing is performed, a separated signal corresponding to the object sound can be obtained. However, depending on an acoustic environment, signal components of noises other than the object sound are contained in the separated signal at a relatively high rate. For example, in the sound source separation processing in the BSS method based on the ICA, under an environment that the number of the sound sources of the object sound and the other noises is larger than the number of the microphones, or the noises are reflected or echoed, the sound source separation processing is decreased.

As acoustic input device that realizes sharp directional characteristics, for example, an acoustic input device having a microphone array and a delay sum type filter has been known. However, the size of the device becomes larger as the directivity is sharpened.

### SUMMARY OF THE INVENTION

Accordingly, the present invention has been made in view of the above, and an object of the present invention is to provide an object sound extraction apparatus, an object sound extraction program, and an object sound extraction method capable of ensuring a high object sound extraction performance (noise removal performance) using a small device under an acoustic environment where an object sound and the other noises (non-object sounds) are mixed in acoustic signals obtained via microphones and the mixed conditions can be varied.

To achieve the above object, object sound extraction apparatus according to first to third aspects of the present invention, based on a main acoustic signal obtained via a main microphone that mainly inputs a sound (hereinafter, referred to as object sound) outputted from a predetermined object sound source (certain sound source), and sub acoustic signals other than the object sound obtained via sub microphones (microphones disposed at positions different from a position of the main microphone, or microphones having directivities in directions different from a directivity of the main microphone), extract an acoustic signal corresponding to the object sound and output the extracted signal.

According to the first aspect of the present invention, structural elements shown in the following (1-1) to (1-3) are provided.

(1-1) Sound source separation sections for performing a sound source separation processing for separating and generating an object sound separation signal corresponding to the object sound and reference sound separation signals corresponding to the reference sound (may be called as noise) other than the object sound based on each combination of the main acoustic signal and the sub acoustic signals.
(1-2) An object sound separation signal synthesis section for synthesizing the object sound separation signals and outputting a synthesis signal.
(1-3) A spectrum subtraction processing section for extracting an acoustic signal corresponding to the object sound from the synthesis signal by performing a spectrum subtraction processing between the synthesis signal and the reference sound separation signals, and outputting the extracted signal.

In the first aspect of the present invention, the object sound separation signals separated and generated by the sound source separation processing section contain signal components of the object sound as main components. Similarly, the reference sound separation signals separated and generated by the sound source separation processing section contain signal components of the sounds (sounds other than the object sound (reference sounds)) of noise sound sources in each sound collection area of the sub microphones, which are disposed at different positions and have different directivities, as main components.

However, depending on the positions of the object sound source or noise generation environments to the microphones (the main microphone and the sub microphones), in the object sound separation signals, a relatively large amount of signal components of the reference sound signals other than the object sound may remain. Accordingly, basically, though the synthesis signal formed by synthesizing the signal components contain the signal components of the object sound as main components, depending on environments, a relatively large amount of noise signal components may remain.

Meanwhile, if the components of the noise sounds (reference sounds) other than the object sound are contained in the object sound separation signals, the signal formed by extracting the signal components of the object sound from the synthesis signal by the spectrum subtraction processing is a signal formed by removing the signal components of the reference sound separation signals. Further, the extraction signal formed by the spectrum subtraction processing section is a signal formed, even in an environment where different noises (reference sounds) from a plurality of directions arrive at the main microphone, by removing entire signal components of the reference sound separation signals corresponding to the noises.

Accordingly, by performing the spectrum subtraction processing that removes the signal components in each of the reference sound separation signals to the synthesis signal of the object sound separation signals, a high noise removal performance can be ensured even in the environment where the relatively strong particular noise arrives at the main microphone or the environment where the different noises arrive at the main microphone from the plurality of directions.

According to the second aspect of the present invention, structural elements shown in the following (2-1) to (2-2) are provided.

(2-1) Sound source separation sections for performing a sound source separation processing for separating and generating an object sound separation signal corresponding to the object sound based on each combination of the main acoustic signal and the sub acoustic signals.
(2-2) A spectrum approximate signal extraction section for extracting an acoustic signal corresponding to the object sound from the object sound extraction signals and outputting the extracted signal by dividing the object sound separation signals into signal components of each of a plurality of frequency bands, and extracting signal components that satisfy a predetermined approximation condition between the object sound separation signals.

For example, the sound source separation processing performed by the sound source separation sections may be a sound source separation processing according to a blind source separation method based on an independent component analysis, or a sound source separation processing according to a binary masking processing.

In the second aspect of the present invention, the object sound separation signals separated and generated by the sound source separation processing section contain signal components of the object sound as main components. However, depending on the positions of the object sound source or noise generation environments to the microphones (the main microphone and the sub microphones), in the object sound separation signals, a relatively large amount of signal components of noises other than the object sound may remain. Even in the case, since the positions or the directions of the directivities of the microphones differ from each other, generally, the object sound separation signals containing many noise components are a part of the all object sound separation signals or the types of the noise components contained in each object sound separation signal are different. Accordingly, by extracting the approximated signal components in the object sound separation signals by the spectrum approximation extraction section, a high noise removal performance can be ensured even in the environment where the relatively strong particular noise arrives at the main microphone or the environment where the different noises arrive at the main microphone from the plurality of directions.

According to the third aspect of the present invention, structural elements shown in the following (3-1) and (3-2) are provided.

(3-1) Sound source separation sections for performing a sound source separation processing for separating and generating a reference sound separation signal corresponding to the reference sound other than the object sound based on each combination of the main acoustic signal and the sub acoustic signals.
(3-2) A spectrum subtraction processing section for extracting an acoustic signal corresponding to the object sound from the main acoustic signal and outputting the extracted signal by performing a spectrum subtraction processing between the reference sound separation signals separated and generated by the main acoustic signal and the sound source separation sections.

For example, the sound source separation processing performed by the sound source separation sections may be a sound source separation processing according to a blind source separation method based on an independent component analysis, or a sound source separation processing according to a binary masking processing.

In the third aspect of the present invention, the reference sound separation signals separated and generated by the sound source separation processing section contain signal components of the sounds (noises) other than the object sound as main components. Meanwhile, in the main acoustic signal, a relatively large amount of signal components of the noises other than the object sound may remain.

Even if the components of the noise sounds (reference sounds) other than the object sound are contained in the main acoustic signal, the signal formed by extracting the signal components of the object sound from the main acoustic signal by the spectrum subtraction processing is a signal formed by removing the signal components of the reference sound separation signals. Further, the extraction signal formed by the spectrum subtraction processing section is a signal that is formed, even in an environment where different noises (reference sounds) from a plurality of directions arrive at the main microphone 101, by removing entire signal components of the reference sound separation signals corresponding to the noises.

Accordingly, by performing the spectrum subtraction processing that removes the signal components in each of the reference sound separation signals to the main acoustic signal, a high noise removal performance can be ensured even in the environment where the relatively strong particular noise arrives at the main microphone 101 or the environment where the different noises arrive at the main microphone 101 from the plurality of directions.

The sound source separation processings performed by the sound source separation sections according to the first to third aspect of the present invention may be sound source separation operations according to a blind source separation method based on an independent component analysis, or a sound source separation processings according to a binary masking processing.

Generally, in the sound source separation processing according to the ICA-BSS method, to obtain a high sound source separation performance, it is necessary to increase the number of the sequential calculations (learning calculations) for calculating a separation matrix used for a separation processing (filter processing), or to increase the number of samples of acoustic signals (digital signals) used for the sequential calculations. Then, the calculation loads are increased. For example, if the sequential calculations are performed by a practical processor, to a length of time of the inputted acoustic signal, several times of time may be required, and not suitable for real time processing. However, the calculation load in the spectrum subtraction processing is relatively small, and if the processing is performed using the practical processor, real time processing can be performed.

In view of the above, the sound source separation sections in the object sound extraction apparatus according to the first to third aspect of the present invention may perform sound source separation processing shown in (6) or (7) below.

(6) The sound source separation processing is a sound source separation processing according to the blind source separation method based on the independent component analysis, and in the processing, the number of the sequential calculations is limited to a predetermined number (the number of calculations to enable to complete the calculation processing of the separation matrix within time of a predetermined period) by sequentially performing a filter processing based on a predetermined separation matrix to generate separation signals to the acoustic signals (the main acoustic signal and the sub acoustic signals) time-sequentially inputted via the microphones, and performing a sequential calculation for calculating the separation matrix that is to be used for the filter processing that is subsequently performed using all block signals for each block signal divided in a predetermined period in the acoustic signals.
(7) The sound source separation processing is the sound source separation processing according to the blind source separation method based on the independent component analysis, and the processing, to the acoustic signals (the main acoustic signal and the sub acoustic signals) time-sequentially inputted via the microphones, sequentially performs a filter processing based on a predetermined separation matrix to generate separation signals, and performs a sequential calculation for calculating the separation matrix that is to be used for the filter processing that is subsequently performed using signals (the signals of the number of samples to enable to complete the calculation processing of the separation matrix within the time of the predetermined period) for each of the signals of a part of time at a head side of block signals divided in a predetermined period in the time-sequentially inputted acoustic signals.

In the sound source separation processings shown in (6) and (7), the calculation loads in the filter processings are small. Accordingly, if the filter processings are performed together with the spectrum subtraction processing by a practical processor, the processing can be relatively easily performed in real time.

Further, in the sequential calculations (learning calculations) in the sound source separation processings shown in (6) and (7), the number of the sequential calculations and the number of samples (time) of the acoustic signals (digital signals) used in the sequential calculations are limited, and the calculation loads are small. Accordingly, if the sequential calculations (learning calculations) are performed together with the filter processing and the spectrum subtraction processing (real time processing) by a practical processor, the processing (calculation of the separation matrix that is used for a subsequent processing) can be completed in relatively short time. As a result, the separation matrix to be used in the filter processing is quickly updated in a condition corresponding to a changed acoustic environment, and the ability in the object sound extraction to adapt to change in the acoustic environments can be increased. Further, by the simplification in the sequential calculation (learning calculation), even if some noises are contained in the separation signals obtained by the sound source separation processing, by the combination of the sound source separation processing and the spectrum subtraction processing, the object sound extraction performance can be efficiently ensured as a whole.

It is preferable that the object sound extraction apparatus according to the first to third aspects of the present invention further include structural elements shown in the following (10) and (11).

(10) A main/sub acoustic signal specification section for specifying the main acoustic signal and the sub acoustic signals from three or more acoustic signals based on three or more inputted acoustic signals obtained via three of more microphones (including a microphone that functions as the main microphone and microphones that function as the sub microphones) that are disposed at different positions or have directional directivities different from each other.
(11) A signal switching section for switching transmission paths of the acoustic signals from the three or more microphones to the sound source separation sections according to a result specified by the main/sub acoustic signal specification section.

For example, the main/sub acoustic signal specifying section may specify the main acoustic signal and the sub acoustic signals based on a comparison between signal strengths of each of the three or more inputted acoustic signals, or, based on a comparison between ratios of predetermined frequency components of each of the three or more inputted acoustic signals. With the structural elements, the object sound extraction apparatus according to the aspects of the present invention can be applied to a target for which a predetermined microphone in the microphones cannot be fixed because the position of the object sound source can vary.

The first to third aspects of the present invention may be considered as object sound extraction methods for implementing the processings performed by each section in the object sound extraction apparatus. By the object sound extraction methods, similar effects to those in the object sound extraction apparatus according to the above-described aspects of the present invention may be obtained.

According to an aspect (corresponding to a first embodiment described below) of the present invention, a high noise removal performance can be ensured even in an environment where different noises arrive at each microphone from a plurality of directions, or an environment where an object sound of a relatively large volume is mixed in one of the sub microphones, and further, such acoustic environments vary.

Further, according to the aspects of the present invention, as will be described below, if the directivity of the main microphone itself is gradual, the object sound extraction apparatus according to the aspects of the present invention can function as an acoustic input device that has a very sharp directivity. Further, by adjusting (moving close or away) the positions or directional directions of the sub microphones to the position or the directional direction of the main microphone, a position or direction of a sound source of a sound to be treated (removed) as a noise can be adjusted. Accordingly, the directional performance of the object sound extraction apparatus according to the aspects of the present invention can be adjusted and convenience can be enhanced. Further, as will be described below, the device that functions as the acoustic input device having the sharp or flexible directivity can be realized as a very small device.

### BRIEF DESCRIPTION OF THE DRAWINGS

FIG. 1 is a block diagram illustrating a schematic configuration of an object sound extraction apparatus X1 according to a first embodiment of the present invention;

FIG. 2 is a conceptual diagram illustrating process in the object sound extraction apparatus X1;

FIG. 3 is a block diagram illustrating a schematic configuration of an object sound extraction apparatus X2 according to a second embodiment of the present invention;

FIG. 4 is a conceptual diagram illustrating process in the object sound extraction apparatus X2;

FIG. 5 is a block diagram illustrating a schematic configuration of an object sound extraction apparatus X3 according to a third embodiment of the present invention;

FIG. 6 is a conceptual diagram illustrating process in the object sound extraction apparatus X3;

FIG. 7 is a view illustrating first experimental conditions for evaluating object sound extraction performances of the object sound extraction apparatus X1 to X3.

FIG. 8 is a view illustrating second experimental conditions for evaluating object sound extraction performances of the object sound extraction apparatus X1 to X3.

FIG. 9 is a view illustrating the object sound extraction performances of the object sound extraction apparatus X1 to X3 and a known object sound extraction apparatus under the first experimental conditions;

FIG. 10 is a view illustrating the object sound extraction performances of the object sound extraction apparatus X1 to X3 and a known object sound extraction apparatus under the second experimental conditions;

FIG. 11 is a view illustrating third experimental conditions for evaluating a directivity of the object sound extraction apparatus X1.

FIG. 12 is a view illustrating the directivity of the object sound extraction apparatus X1 under the third experimental conditions.

FIG. 13 is a block diagram illustrating a schematic configuration of an acoustic input device V2 that can be employed in the object sound extraction apparatus X1 to X3;

FIG. 14 is a block diagram illustrating a schematic configuration of a sound source separation device Z that performs a sound source separation processing in the BSS method based on FDICA;

FIG. 15 is a time chart illustrating a first example of a processing sequence in a sound source separation processing except for a learning calculation in the object sound extraction apparatus X1 to X3;

FIG. 16 is a time chart illustrating a second example of a processing sequence in a sound source separation processing except for a learning calculation in the object sound extraction apparatus X1 to X3;

FIG. 17 is a time chart illustrating a sequence of a learning calculation in the sound source separation processings in the object sound extraction apparatus X1 to X3 according to a first embodiment; and

FIG. 18 is a time chart illustrating a sequence of a learning calculation in the sound source separation processings in the object sound extraction apparatus X1 to X3 according to a second embodiment.

### DESCRIPTION OF THE PREFERRED EMBODIMENTS

### First Embodiment

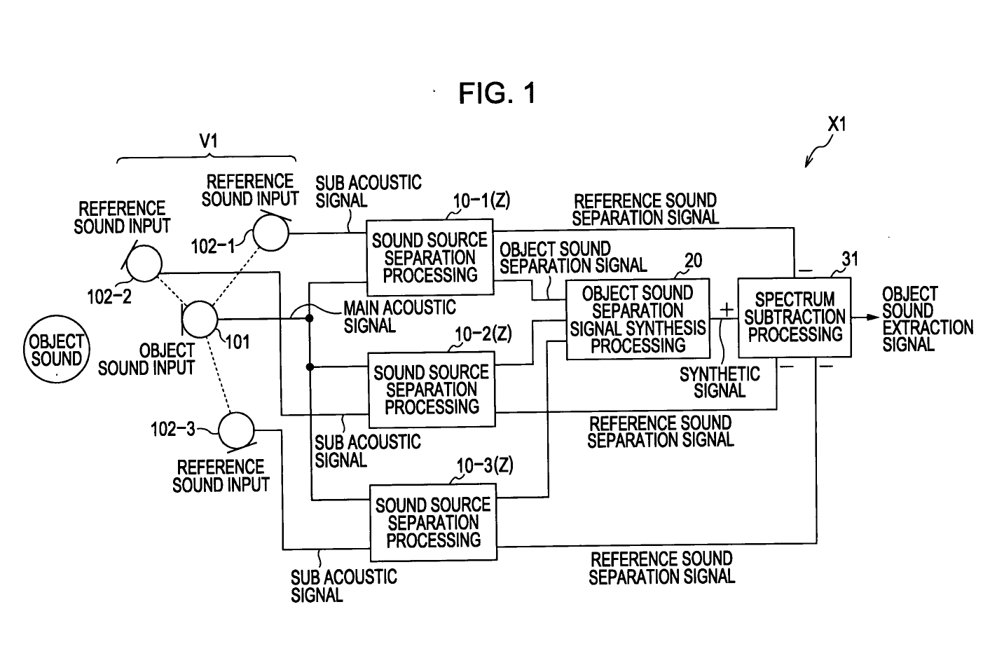

First, an object sound extraction apparatus X1 according to a first embodiment of the present invention is described with reference to a block diagram illustrated in FIG. 1.

As illustrated in FIG. 1, the object sound extraction apparatus X1 includes an acoustic input device V1 that has microphones, a plurality of (three in FIG. 1) sound source separation processing sections 10 (10-1 to 10-3), an object sound separation signal synthesis processing section 20, and a spectrum subtraction processing section 31. The acoustic input device V1 includes a main microphone 101 and a plurality of (three in FIG. 1) sub microphones 102 (102-1 to 102-3). The main microphone 101 and the sub microphones 102 are disposed at positions different from each other, or, have directivities in directions different from each other.

The main microphone 101 is acoustic input means that mainly inputs sound (hereinafter, referred to as object sound) generated by a predetermined object sound source (for example, a speaker who can move in a predetermined area).

The sub microphones 102-1 to 102-3 are disposed at positions different from the position of the main microphone 101 respectively, or, have the directivities in the directions different from each other. The sub microphones are acoustic input means that mainly input reference sounds (noises) other than the object sound. The expression “sub microphones 102” is a generic term of the sub microphones 102-1 to 102-3.

Each of the main microphone 101 and the sub microphones 102 illustrated in FIG. 1 has a directivity. The sub microphones 102 are disposed so that the sub microphones 102 have directivities in directions different from that of the main microphone 101 respectively.

If each of the main microphone 101 and the sub microphones 102 have each directivity, if a directional central direction (front direction) of the main microphone 101 is a center (0°), it is preferred that directional central directions (front directions) of the sub microphones 102 are set in one direction less than +180° (for example, in a direction of +90°), and in the other direction less than −180° (for example, in a direction of −90°) respectively.

The directional directions of the main microphone 101 and the sun microphones 102 may be set in different directions in a plane, or set in three-dimensionally different directions.

The object sound extraction apparatus X1 extracts an acoustic signal corresponding to the object sound based on a main acoustic signal obtained via the main microphone 101 and sub acoustic signals obtained via the sub microphones 102 other than the main acoustic signal, and outputs an extraction signal (hereinafter, referred to as object sound extraction signal).

In the object sound extraction apparatus X1, the sound source separation processing sections 10, the object sound separation signal synthesis processing section 20, and the spectrum subtraction processing section 31 are realized, for example, by Digital Signal Processor (DSP) and a read-only memory (ROM) that stores a program implemented by the DSP, or an application specific integrated circuit (ASIC). In this case, the ROM stores a program for instructing the DSP to implement processing (described below) performed by the sound source separation processing sections 10, the object sound separation signal synthesis processing section 20, and the spectrum subtraction processing section 31 in advance.

The sound source separation processing sections 10 (10-1 to 10-3) are provided for each combination of the main acoustic signal and the sub acoustic signals. Based on the combination of the main acoustic signal and the sub acoustic signals, an sound source separation processing is performed. In the sound source separation processing, an object sound separation signal that is a separation signal (identification signal of object sound) corresponding to the object sound and a reference sound separation signal (identification signal of reference sound) corresponding to the reference sounds (can be referred to as noises) that are the sounds other than the object sound are separated and generated (an example of the sound source separation sections).

Between the main microphone 101, the sub microphones 102, and the sound source separation processing sections 10, analog-digital converters (A/D converters, not shown) are provided. Acoustic signals that are converted into digital signals by the A/D converters are transmitted to the sound source separation processing sections 10. For example, if the object sound is a human voice, the voice can be digitalized in a sampling period of about 8 kHz.

The sound source separation processing sections 10 (10-1 to 10-3) implement a sound source separation processing according to the ICA-BSS method, a sound source separation processing according to the binary masking processing, or the like.

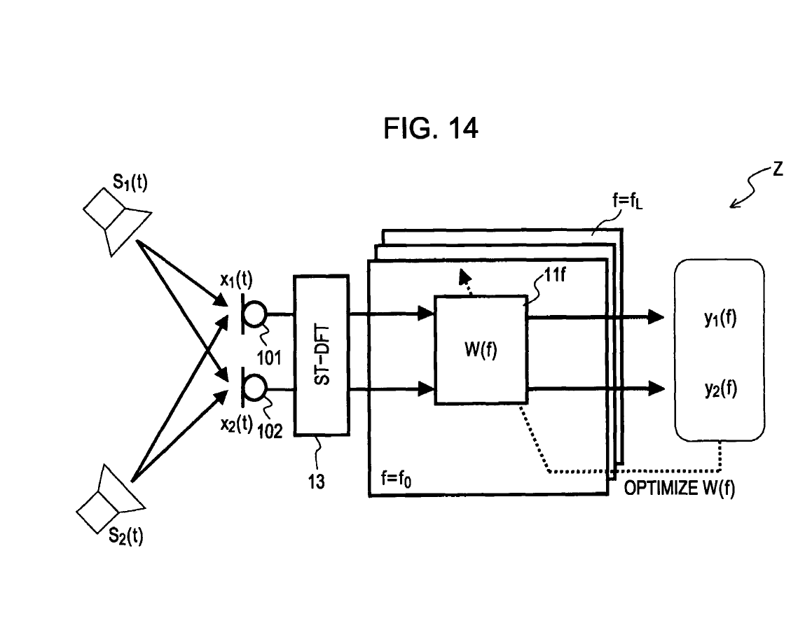

Now, with reference to a block diagram in FIG. 14, a sound source separation device Z that is an example of a device that can be employed as the sound source separation processing sections 10 is described.

The sound source separation device Z described below performs a processing for sequentially generating a plurality of separation signals (signals identified sound source signals) corresponding to sound source signals. In the processing for sequentially generating the separation signals, in a state that a plurality of sound sources and a plurality of microphones 101 and 102 exist, in a case where a plurality of mixed sound signals in which individual sound signals (hereinafter, referred to as sound source signals) inputted from each sound source via the microphones 101 and 102 are superimposed are sequentially inputted, the sound source separation processing according to the BSS-ICA method is performed to the mixed sound signals to sequentially generate the separation signals corresponding to the sound source signals.

The sound source separation device Z illustrated in FIG. 14 performs a sound source separation processing based on a Frequency-Domain ICA (FDICA) method that is one of the ICA-BSS methods.

In the FDICA method, first, with respect to an inputted mixed sound signal x(t), Short Time Discrete Fourier Transform (hereinafter, referred to as SIGNAL TERMINAL-DFT processing) is performed for each frame that is a signal divided into a predetermined period by a SIGNAL TERMINAL-DFT processing section 13 to perform short time analysis of an observation signal. Then, with respect to the SIGNAL TERMINAL-DFT processed signal of each channel (signal of each frequency component), a separation calculation processing (filter processing) based on a separation matrix W(f) is performed by a separation calculation processing section 11f to separate a sound source (identify sound source). If f is a frequency bin, and m is a analysis frame number, a separation signal (identification signal) y (f,m) can be expressed as the following equation (1).

### Equation (1)

Y(f,m)=W(f)·X(f,m)(1)

As understood from the equation (1), the separation calculation processing (filter processing) is performed for each frequency bin. Here, an updating equation of a separation filter W (f) can be expressed as the following equation (2).

### Equation (2)

W_{(ICAl)}^{[i+1]}(f)=W_{(ICAl)}^{[i]}(f)−η(f)[off−diag{ [symbol] φ(Y_{(ICAl)}^{[i]}(f,m))Y_{(ICAl)}^{[i]}(f,m)^{H} [symbol] }]W_{(ICAl)}^{[i]}(f) (2)

wherein, η(f) denotes an update coefficient, i denotes the number of updates, < . . . > denotes a time-averaging operator, and
H denotes a Hermitian transposition.
off-diag X denotes a calculation processing for replacing all diagonal elements in the matrix X with zero.
φ( . . . ) denotes an appropriate nonlinear vector function that has a sigmoidal function or the like as elements.

According to the FDICA method, the sound source separation processing is considered as an instantaneous mixture in each narrow band, and the separation filter (separation matrix) W (f) can be relatively easily and stably updated.

In FIG. 14, a separation signal y₁ (f) corresponding to the main microphone 101 is the object sound separation signal. A separation signal y₂ (f) corresponding to the sub microphone 102 is the reference sound separation signal.

In FIG. 14, the number of channels (that is, the number of microphones) of the mixed sound signals x₁ and x₂ to be inputted is two. However, if (the number of channels n)≧(the number of sound sources m) is satisfied, even if the number of the channels is three or more, the sound source separation operation can be performed by a similar configuration.

In the object sound extraction apparatus X1, the object sound separation signal synthesis processing section 20 performs a synthesis processing of the object sound separation signals that are separated and generated by the sound source separation processing sections 10 respectively, and outputs the obtained synthesis signal (an example of the object sound separation signal synthesis section).

For example, with respect to the object sound separation signals, the object sound separation signal synthesis processing section 20 performs an averaging processing or a weighted averaging processing for each frequency component (frequency bin) that is formed by dividing into a plurality of components, or the like to synthesize the object sound separation signals.

Further, in the object sound extraction apparatus X1, the spectrum subtraction processing section 31 performs a spectrum subtraction processing between the synthesis signal obtained by the object sound separation signal synthesis processing section 20 and the reference sound separation signals separated and generated by the sound source separation sections 10 respectively to extract an acoustic signal corresponding to the object sound from the synthesis signal and outputs the extraction signal (the object sound extraction signal) (an example of the spectrum subtraction processing means).

The spectrum subtraction processing section 31 performs the processing to extract the object sound extraction signal by removing each signal component of the reference sound separation signal from the synthesis signal using a known spectrum subtraction processing (object sound extraction processing based on a spectrum difference method).

In the spectrum subtraction processing, with respect to each of the synthesis signal and the reference sound separation signal, the spectrum subtraction processing section 31 performs the DFT processing for each frame of a predetermined length of time, and performs a short time analysis of an observation signal (here, the synthesis signal).

Here, if a frequency bin is f, a analysis frame number is m, a spectrum value (signal value after the DFT is performed) of the synthesis signal, which is the observation signal, is Y(f,m), a spectrum value of an object sound signal is S(f,m), and a spectrum value of a noise signal (signal of a sound other than the object sound) is N(f,m), the spectrum value of the synthesis signal is expressed as following equation (3).

### Equation (3)

Y(f,m)=S(f,m)+N(f,m) (3)

wherein, f denotes the frequency bin, m denotes the analysis frame number,
Y(f,m) denotes the spectrum value of the observation signal,
S(f,m) denotes the spectrum value of the object sound signal,
N(f,m) denotes the spectrum value of the noise signal.

Here, it is assumed that there is no correlation between the object sound signal and the noise signal, and further, the spectrum value N(f,m) of the noise signal can be approximated by the spectrum value of the reference sound signal, the spectrum subtraction processing section 31 can calculate a spectrum estimation value (that is, a spectrum value of the object sound extraction signal) of the object sound signal based on the following equation (4).

$$\begin{matrix}Equation ( 4 ) & \\ \vert \hat{S} ( f , m ) \vert = \{ \begin{matrix}\vert Y ( f , m ) \vert - a \vert \hat{N} ( f , m ) \vert & if \vert Y ( f , m ) \vert > α \vert \hat{N} ( f , m ) \vert \\ β \vert Y ( f , m ) \vert & otherwise\end{matrix} & ( 4 )\end{matrix}$$

|Ŝ(f,m)| denotes the spectrum estimation value of the object sound signal,
|\hat{N}(f,m)| denotes the spectrum approximation value (spectrum value of the reference sound signal) of the noise signal,
α denotes a subtraction coefficient: 0<α, and β denotes a suppression coefficient: 0≦β≦1

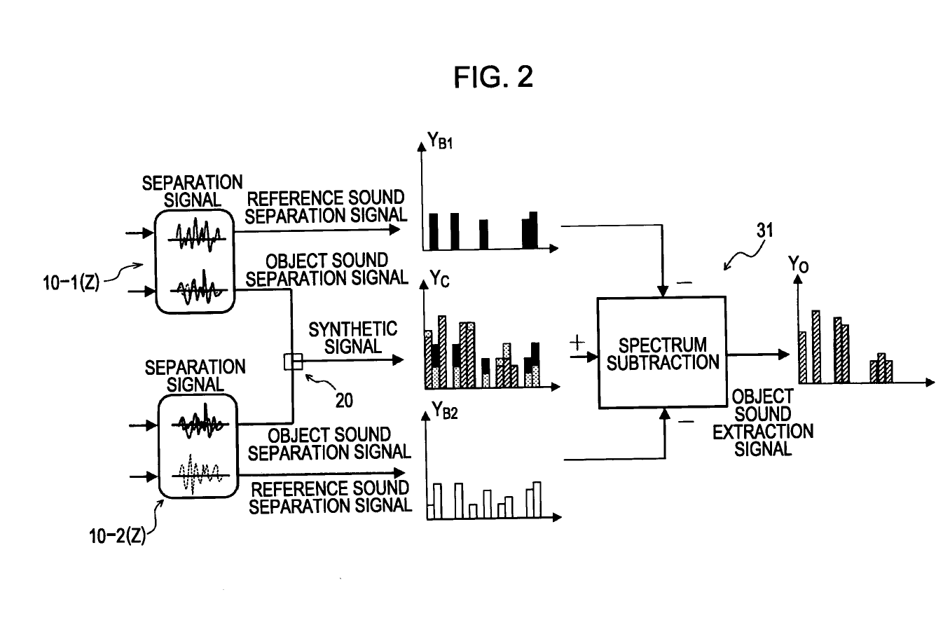

With reference to FIG. 2, process of an object sound extraction processing in the object sound extraction apparatus X1 is described. For the sake of simplicity, FIG. 2 illustrates an example that two sub acoustic signals are used (that is, two sub microphones 102 are used).

The object sound separation signals separated and generated by the sound source separation processing sections 10 contain signal components of the object sound as main components. Similarly, the reference sound separation signals (Y_{B1} and Y_{B2} in FIG. 2) separated and generated by the sound source separation processing sections 10 contain signal components (components indicated by bar graphs other than bar graphs of oblique lines in FIG. 2) of the sounds (reference sounds) of noise sound sources in each sound collection area of the sub microphones 102, which are disposed at different points and have different directivities, as main components.

However, depending on the positions of the object sound source or noise generation environments, in the object sound separation signals, a relatively large amount of signal components of the reference sound signals other than the object sound may remain. Accordingly, basically, though the synthesis signal (Y_{C} in FIG. 2) formed by synthesizing the signal components contain the signal components (components indicated by the bar graphs of oblique lines in FIG. 2) of the object sound as main components, depending on environments, a relatively large amount of noise signal components may remain.

Meanwhile, if the components of the noise sounds (reference sounds) other than the object sound are contained in the object sound separation signals, the object sound extraction signal (Yₒ in FIG. 2) that is a result of the extraction of the signal components of the object sound from the synthesis signal by the spectrum subtraction processing section 31 is a signal formed by removing the signal components of the reference sound separation signals. Further, the object sound extraction signal is a signal formed, even in an environment where different noises (reference sounds) from a plurality of directions arrive at the main microphone 101, by removing entire signal components of the reference sound separation signals corresponding to the noises.

Accordingly, using the object sound extraction apparatus X1, a high noise removal performance can be ensured even in the environment where the relatively strong particular noise arrives at the main microphone 101 or the environment where the different noises arrive at the main microphone 101 from the plurality of directions.

Further, if, only the spectrum subtraction processing that is a nonlinear processing is used, the output signal (extraction signal of an object sound) can contain a musical noise that is peculiar to the nonlinear processing. However, in the object sound extraction apparatus X1, the spectrum subtraction processing is performed based on the signals on which the linear filter processing is performed by the sound source separation processing sections 10. Accordingly, it is possible to prevent the object sound extraction signal from containing the harsh musical noise. Especially, in a case of simple sound sources, that is, the number of sound sources containing an object sound and noises is small (three or less), the sound source separation processing effectively works on the object sound extraction, and a suppression effect of the musical noises is increased.

### Second Embodiment

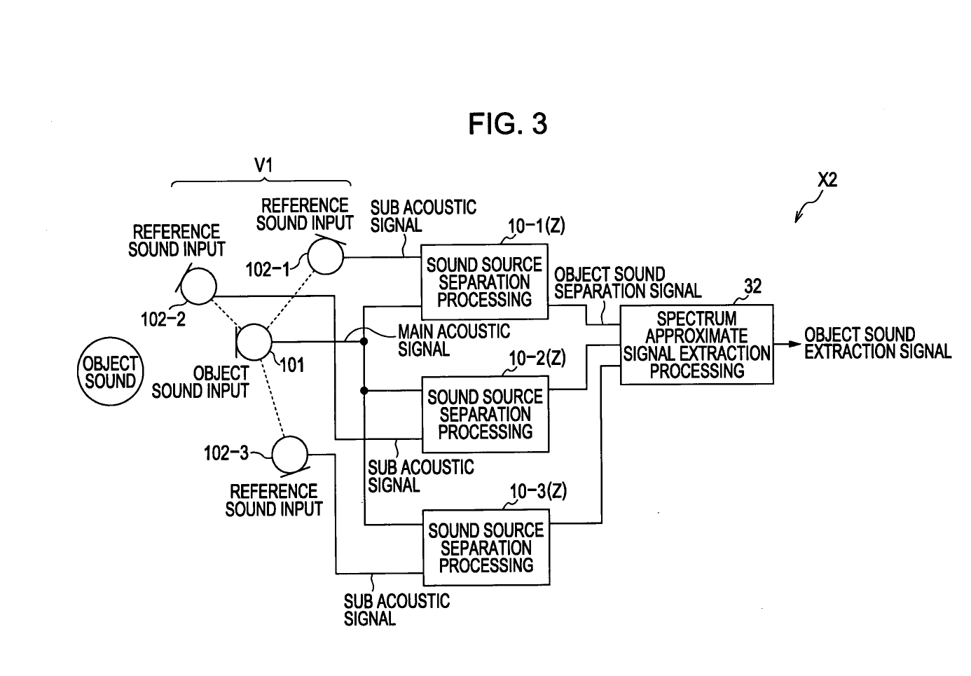

Now, an object sound extraction apparatus X2 according to a second embodiment of the present invention is described with reference to a block diagram illustrated in FIG. 3. In FIG. 3, in structural elements included in the object sound extraction apparatus X2, same reference numerals as those in FIG. 1 are applied to structural elements that perform same processings as in the object sound extraction apparatus X1.

As illustrated in FIG. 3, the object sound extraction apparatus X2 includes the acoustic input device V1 that has the microphones, the plurality of (three in FIG. 3) sound source separation processing sections 10 (10-1 to 10-3), and a spectrum approximate signal extraction processing section 32. The acoustic input device V1 is the same as that in the object sound extraction apparatus X1.

Similarly, the object sound extraction apparatus X2 extracts an acoustic signal corresponding to the object sound based on a main acoustic signal obtained via the main microphone 101 and sub acoustic signals obtained via the sub microphones 102 other than the main acoustic signal, and outputs an extraction signal (the object sound extraction signal).

In the object sound extraction apparatus X2, the sound source separation processing sections 10 and spectrum approximate signal extraction processing section 32 are realized, for example, by a DSP, which is an example of a computer, and a ROM that stores a program implemented by a DSP, or an ASIC. In this case, the ROM stores a program for instructing the DSP to implement processing (described below) performed by the sound source separation processing sections 10 and the spectrum approximate signal extraction processing section 32 in advance.

The sound source separation processing sections 10 (10-1 to 10-3) are provided for each combination of the main acoustic signal and the sub acoustic signals. Based on the main acoustic signal and the sub acoustic signals, an sound source separation processing is performed. In the sound source separation processing, an object sound separation signal that is a separation signal (identification signal) corresponding to the object sound is separated and generated.

Between the main microphone 101, the sub microphones 102, and the sound source separation processing sections 10, similarly to the object sound extraction apparatus X1, A/D converters (not shown) are provided.

Similarly to the object sound extraction apparatus X1, the sound source separation processing sections 10 (10-1 to 10-3) implement a sound source separation processing according to the ICA-BSS method, a sound source separation processing according to the binary masking processing, or the like.

The spectrum approximate signal extraction processing section 32, with respect to the object sound separation signals separated and generated by the sound source separation processing sections 10, extracts signal components that satisfy a predetermined approximation condition between the object sound separation signals from signal components in each frequency band (frequency bin) divided into a plurality of bands to extract an acoustic signal corresponding to the object sound from the object sound separation signals, and outputs the extraction signal (the object sound extraction signal).

For example, the spectrum approximate signal extraction processing section 32, with respect to the object sound separation signals, compares levels (power) of signal components of the object sound separation signals for each frequency bin. If the approximation condition, that is, the ratio or difference of the levels is within a predetermined range, is satisfied, the spectrum approximate signal extraction processing section 32 selects one of the signal components or synthesize the signal components (for example, calculates an average value or a minimum value) to extract the object sound extraction signal.

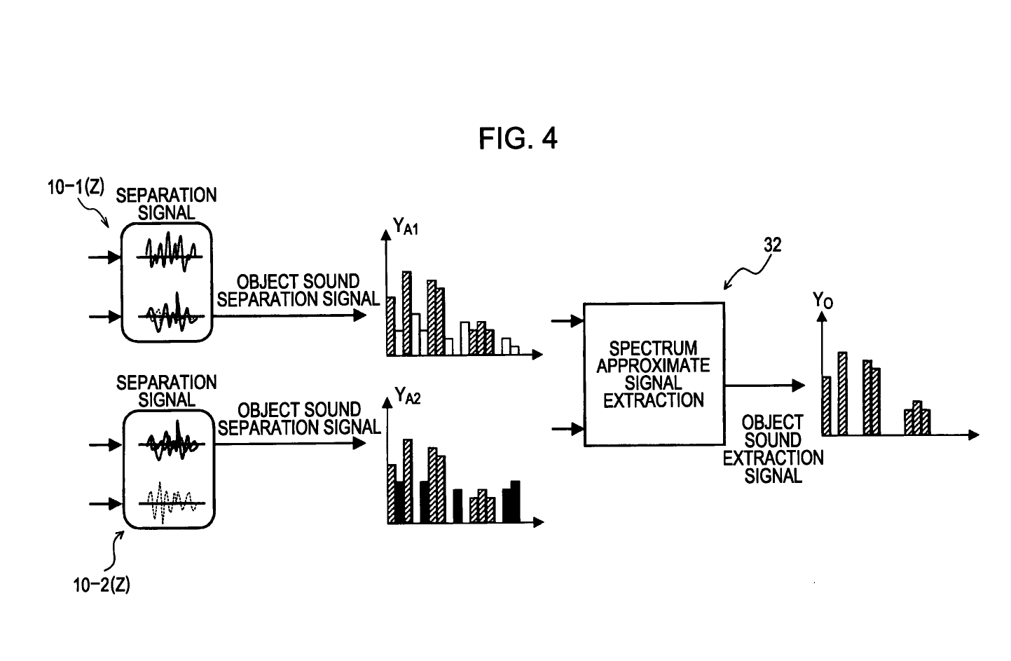

With reference to FIG. 4, process of an object sound extraction processing in the object sound extraction apparatus X2 is described. For the sake of simplicity, FIG. 4 illustrates an example that two sub acoustic signals are used (that is, two sub microphones 102 are used).

The object sound separation signals (Y_{A1} and Y_{A2} in FIG. 4) separated and generated by the sound source separation processing sections 10 contain signal components (components indicated by bar graphs of oblique lines in FIG. 4) of the object sound as main components.

However, depending on the positions of the object sound source or noise generation environments, in the object sound separation signals, a relatively large amount of signal components (components indicated by bar graphs other than the bar graphs of oblique lines in FIG. 4) of reference sound signals other than the object sound may remain.

Meanwhile, even if the components of the noise sounds (reference sounds) other than the object sound are contained, since the positions or the directions of the directivities of the microphones 101 and 102 differ from each other, generally, the object sound separation signals containing many noise components are a part of the all object sound separation signals or the types of the noise components contained in each object sound separation signal are different.

Accordingly, the object sound extraction signal (Yₒ in FIG. 4) that is a result of the extraction of the approximated signal components from the object sound separation signals ((Y_{A1} and Y_{A2} in FIG. 4) by the spectrum approximate signal extraction processing section 32 is a signal from which various noise signal components are removed.

Accordingly, by the object sound extraction apparatus X2, a high noise removal performance can be ensured even in the environment where the relatively strong particular noise arrives at the main microphone 101 or the environment where the different noises arrive at the main microphone 101 from the plurality of directions.

### Third Embodiment

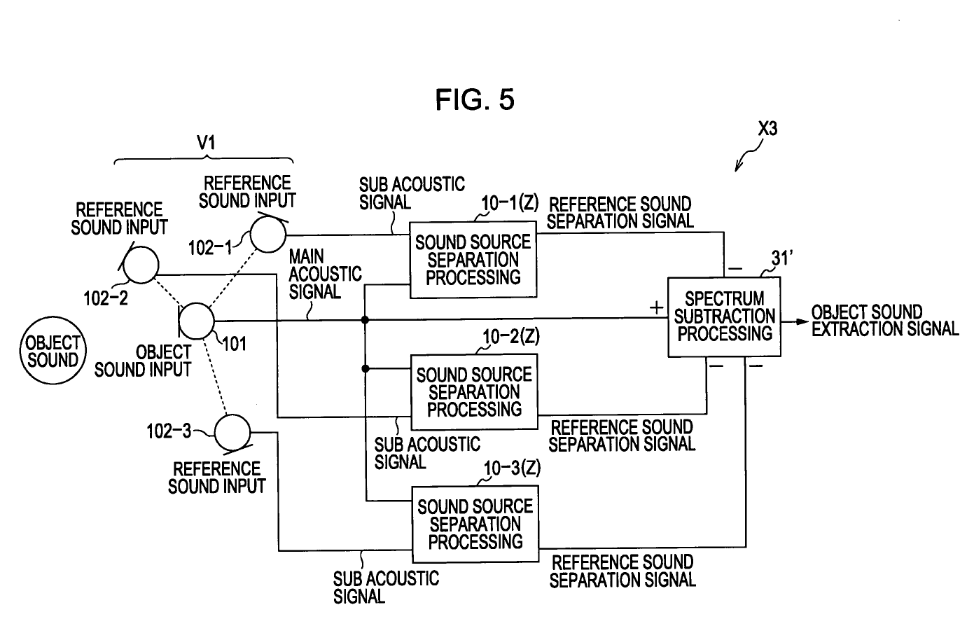

An object sound extraction apparatus X3 according to a third embodiment of the present invention is described with reference to a block diagram illustrated in FIG. 5. In FIG. 5, in structural elements included in the object sound extraction apparatus X3, same reference numerals as those in FIG. 1 are applied to structural elements that perform same processings as in the object sound extraction apparatus X1.

As illustrated in FIG. 5, the object sound extraction apparatus X3 includes the acoustic input device V1 that has the microphones, the plurality of (three in FIG. 5) sound source separation processing sections 10 (10-1 to 10-3), and a spectrum subtraction processing section 31′. The acoustic input device V1 is the same as that in the object sound extraction apparatus X1.

The object sound extraction apparatus X3 extracts an acoustic signal corresponding to the object sound based on a main acoustic signal obtained via the main microphone 101 and sub acoustic signals obtained via the sub microphones 102 other than the main acoustic signal, and outputs an extraction signal (the object sound extraction signal).

In the object sound extraction apparatus X3, the sound source separation processing sections 10 and the spectrum subtraction processing section 31′ are realized, for example, by a DSP, which is an example of a computer, and a ROM that stores a program implemented by a DSP, or an ASIC. In this case, the ROM stores a program for instructing the DSP to implement processing (described below) performed by the sound source separation processing sections 10 and the spectrum subtraction processing section 31′ in advance.

The sound source separation processing sections 10 (10-1 to 10-3) are provided for each combination of the main acoustic signal and the sub acoustic signals. Based on the main acoustic signal and the sub acoustic signals, a sound source separation processing is performed. In the sound source separation processing, a reference sound separation signals that are separation signals (identification signals) corresponding to the noise (reference sounds) other than the object sound are separated and generated.

Between the main microphone 101, the sub microphones 102, and the sound source separation processing sections 10, similarly to the object sound extraction apparatus X1, A/D converters (not shown) are provided.

Similarly to the object sound extraction apparatus X1, the sound source separation processing sections 10 (10-1 to 10-3) implement a sound source separation processing according to the ICA-BSS method, a sound source separation processing according to the binary masking processing, or the like.

The spectrum subtraction processing section 31′ performs the above-described spectrum subtraction processing between the main acoustic signal obtained via the main microphone 101 and the reference sound separations signals separated and generated by the sound source separation processing sections 10 to extract an acoustic signal corresponding to the object sound from the main acoustic signal and outputs the extraction signal (the object sound extraction signal). The spectrum subtraction processing section 31′ performs similar processing to that in the spectrum subtraction processing section 31 in the object sound extraction apparatus X1 except for the change in the target to be processed (observation signal). The target to be processed is changed from the synthesis signal to the main acoustic signal.

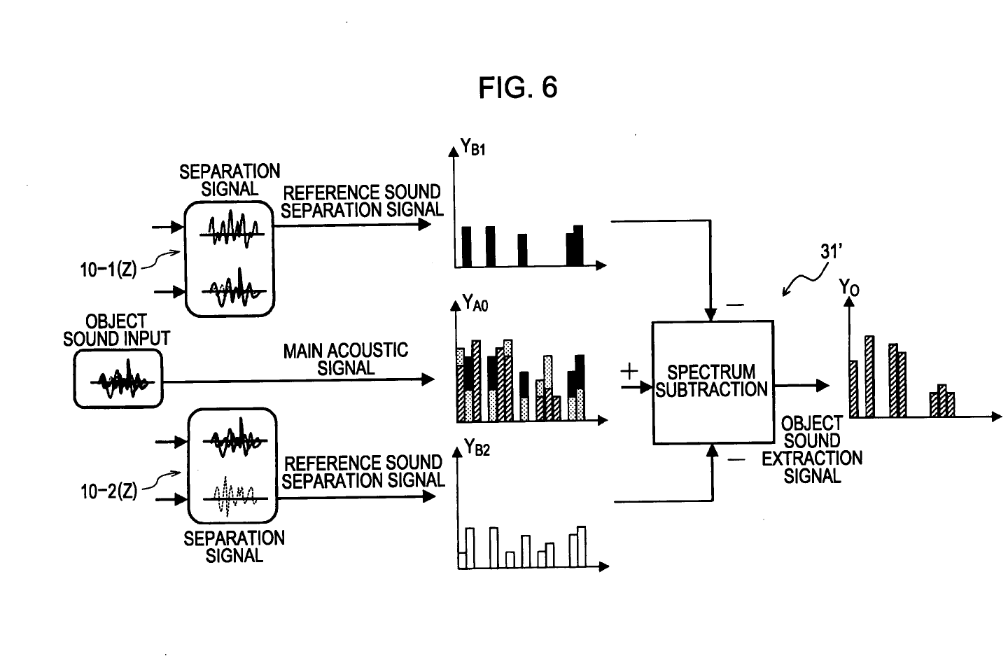

With reference to FIG. 6, process of an object sound extraction processing in the object sound extraction apparatus X1 is described. For the sake of simplicity, FIG. 6 illustrates an example that two sub acoustic signals are used (that is, two sub microphones 102 are used).

The reference sound separation signals (Y_{B1} and Y_{B2} in FIG. 6) separated and generated by the sound source separation processing sections 10 contain signal components (components indicated by bar graphs other than bar graphs of oblique lines in FIG. 6) of the sounds (reference sounds) of noise sound sources in each sound collection area of the sub microphones 102, which are disposed at different points and have different directivities, as main components.

In the main acoustic signal, a relatively large amount of signal components of the reference sounds other than the object sound may remain. Even if the components of the noise sounds (reference sounds) other than the object sound are contained in the main acoustic signal, the object sound extraction signal (Yₒ in FIG. 6) that is a result of the extraction of the signal components of the object sound from the main acoustic signal by the spectrum subtraction processing section 31′ is a signal formed by removing the signal components of the reference sound separation signals. Further, the object sound extraction signal is a signal that is formed, even in an environment where different noises (reference sounds) from a plurality of directions arrive at the main microphone 101, by removing entire signal components of the reference sound separation signals corresponding to the noises.

Accordingly, using the object sound extraction apparatus X3, a high noise removal performance can be ensured even in the environment where the relatively strong particular noise arrives at the main microphone 101 or the environment where the different noises arrive at the main microphone 101 from the plurality of directions.

Further, if, only the spectrum subtraction processing that is a nonlinear processing is used, the output signal (extraction signal of the object sound) can contain a musical noise that is peculiar to the nonlinear processing. However, in the object sound extraction apparatus X3, the spectrum subtraction processing is performed based on the signals on which the linear filter processing is performed by the sound source separation processing sections 10. Accordingly, it is possible to prevent the object sound extraction signal from containing the harsh musical noise. Especially, in a case of simple sound sources, that is, the number of sound sources containing an object sound and noises is small (three or less), the sound source separation processing effectively works on the object sound extraction, and a suppression effect of the musical noises is increased.

The reference sound separation signals that is the result of the processing by the sound source separation sections 10 that implement the sound source separation processing based on the FDICA method, the object sound separation signals and the synthesis signal, and the object sound extraction signal obtained by the spectrum subtraction processing or the spectrum approximate signal extraction processing are acoustic signals in the frequency domain. Accordingly, the object sound extraction apparatus X1, X2, and X3 further include inverse discrete Fourier transform (IDFT) processing sections and acoustic output processing sections (not shown in FIGS. 1, 3, and 5).

The IDFT processing sections perform a processing to convert the object sound extraction signal in the frequency domain into a signal in the time domain, that is, perform a IDFT processing and a processing to output to a predetermined buffer memory.

The acoustic output processing sections sequentially and externally output the object sound extraction signals in the time domain obtained by the IDFT processing sections (for example, output in real time).

### Evaluation of Object Sound Extraction Performance

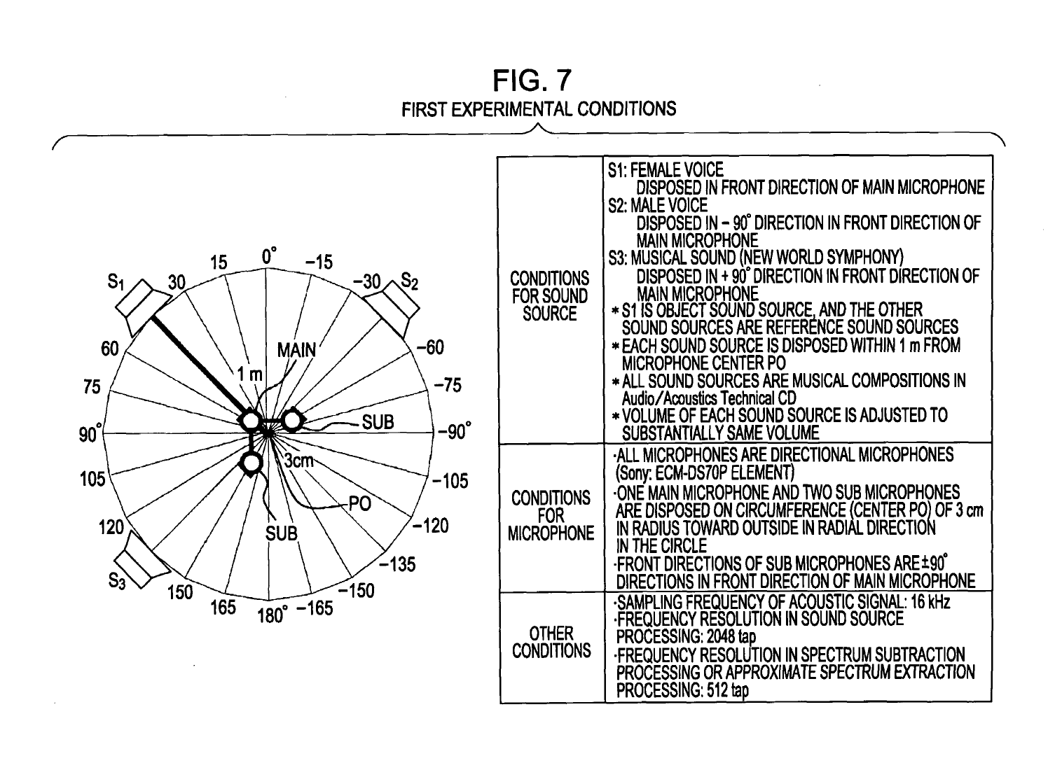

Hereinafter, evaluation results of object sound extraction performances of the above-described object sound extraction apparatus X1 to X3 with reference to FIGS. 7 to 10.

FIGS. 7 and 8 illustrate first experimental conditions and second experimental conditions for evaluating object sound extraction performances of the object sound extraction apparatus X1 to X3.

The first experimental conditions are conditions relatively close to an ideal environment that an object sound source exists in a front direction of the main microphone 101 having a directivity, and other noise sound sources (reference sound sources) exist in front directions of the sub microphones 102 having directivities.

The second experimental conditions are conditions relatively close to an actual usage environment that an object sound source exists in a front direction of the main microphone 101 having a directivity, and directions of other noise sound sources (reference sound sources) do not always correspond to directions of the sub microphones 102.

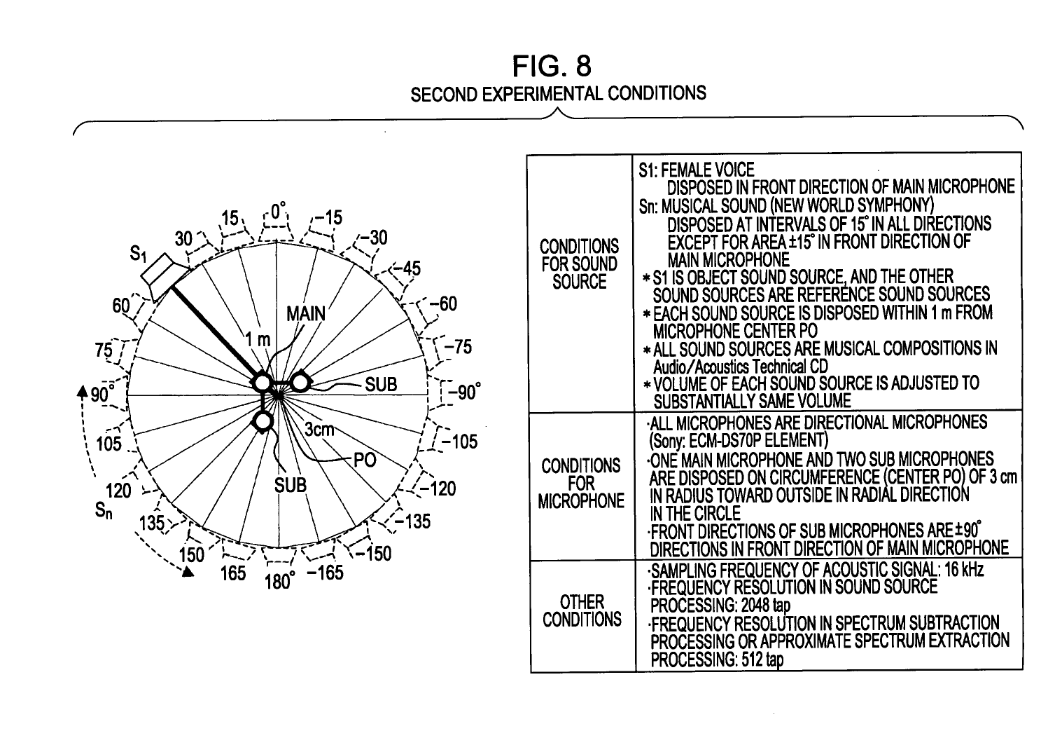

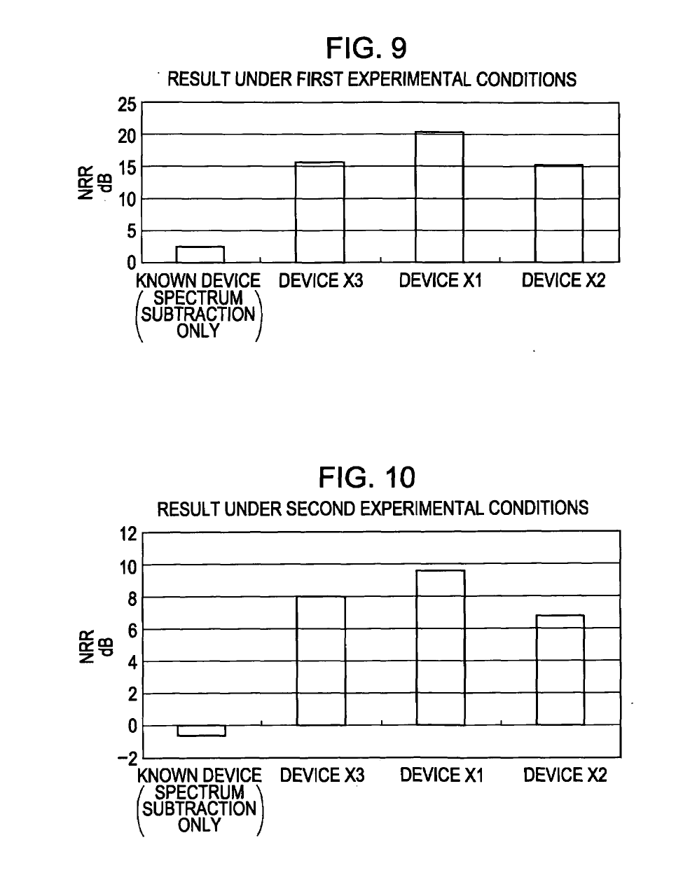

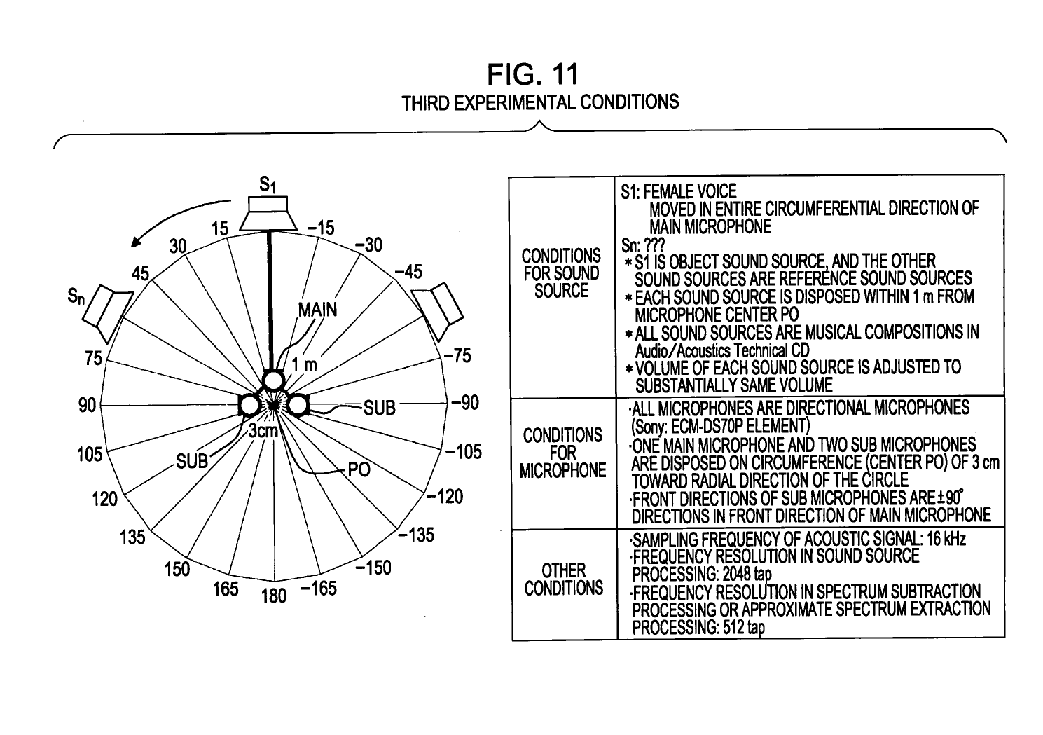

FIGS. 10 and 11 illustrate the object sound extraction performances of the object sound extraction apparatus X1 to X3 and a known object sound extraction apparatus under the first and second experimental conditions by noise reduction rates (NRRs). In FIGS. 9 and 10, the object sound extraction apparatus X1 to X3 are indicated as DEVICE X1 to DEVICE X3 respectively. The known object sound extraction apparatus is indicated as KNOWN DEVICE. The known object sound extraction apparatus extract signal components corresponding to an object sound from a main acoustic signal using a spectrum subtraction processing based on sub acoustic signals.

As understood from FIGS. 9 and 10, in both experimental conditions, remarkably high object sound extraction performances can be obtained by the object sound extraction apparatus X1 to X3 as compared to the known device.

Further, in the object sound extraction apparatus X1 to X3, especially, the object sound extraction performance by the object sound extraction apparatus X1 is high, and high object sound endoscope performances can be obtained in the order of the object sound extraction apparatus X2 and the object sound extraction apparatus X3.

As described above, according to the object sound extraction apparatus X1 to X3, under various acoustic environments, the object sound extraction performance (noise removal performances) higher than the conventional performance can be ensured.

### Evaluation of Directivity

Hereinafter, an evaluation result of the directivity of the object sound extraction apparatus X1 is described with reference to FIG. 11.

FIG. 11 illustrates third experimental conditions for evaluating the directivity of the object sound extraction apparatus X1. The third experimental conditions are directed to evaluate by what rage the object sound extraction apparatus X1 can extract the object sound with a front direction of the main microphone 101 as a reference by moving an object sound source.

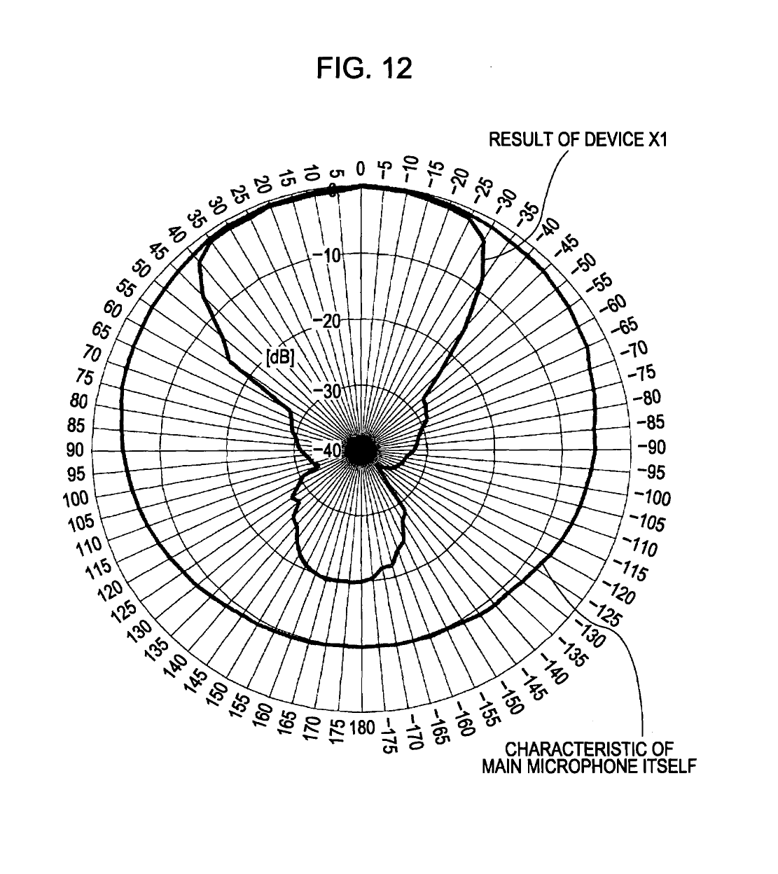

FIG. 12 illustrates directive characteristics of the object sound extraction apparatus X1 and the main microphone 101 itself having a directivity under the third experimental conditions, that is, microphone sensitivities (section diaphragm blade) to the sound source in 360-degree directions.

As understood from FIG. 12, the directivity of the main microphone 101 itself is very gradual. On the other hand, the object sound extraction apparatus X1 has very high NRRs within a narrow range with a center of the front direction of the main microphone 101, and if the object sound source is moved without the range, the NRRs rapidly decrease.

Accordingly, although the directivity of the main microphone 101 itself is very gradual, as the object sound extraction apparatus X1, the device functions as an acoustic input device having the very sharp directivity.

In the result illustrated in FIG. 12, directions about between +45° and −450 with the center (0° direction) of the front direction (central direction of the directional range) of the main microphone 101 are directions the boundary of the range of the directivity is formed.

Meanwhile, in the third experimental conditions, the main microphone 101 and the sub microphones 102, which are substantially symmetrical each other and have substantially same directivity characteristics are set such that to the directional central direction of the main microphone 101 (0° direction), the directional central directions of the two sub microphones 102 are +90° and −90° respectively. Accordingly, in the object sound extraction apparatus X1 to X3, if the main microphone 101 and the sub microphones 102 are substantially symmetrical each other and have substantially same directivity characteristics, the directions that form the boundaries of the directivities face intermediate directions between the directional central direction of the main microphone 101 and the directional central directions of the two sub microphones 102 respectively.

Further, in the example illustrated in FIG. 12, the directional directions of the microphones 101 and 102 are set in the directions different from each other in the plane. However, if the directional directions are set in three-dimensionally different directions, a boundary of a range in the directivity can be set in a three-dimensionally desired direction.

For example, in a plane, the front direction of the main microphone 101 can be set to 0°, and front directions of the two sub microphones 102-1 and 102-2 can be set to +90° and −90° respectively. Further, the front direction of the sub microphone 102-3 can be set to a direction perpendicular to the plane. With the setting, the directional characteristic of the object sound extraction apparatus X1 can be set to a three-dimensionally desired characteristic.

Accordingly, to the object sound extraction apparatus X1, by providing an operation section such as a switch or dial for adjusting (moving close or away) the positions or directional directions of the sub microphones 102 to the position or the directional direction of the main microphone 101, the directional performance of the object sound extraction apparatus X1 can be readily adjusted and convenience can be enhanced.

The object sound extraction apparatus X2 and X3 similarly have the directional performance of the object sound extraction apparatus X1.

As the acoustic input device that realizes a sharp directional characteristic, for example, an acoustic input device that has a microphone array and a delay sum type filter has been known. However, in such known acoustic input device, to realize the sharp directivity illustrated in FIG. 12, it is necessary to increase the number of the microphones that form the microphone array, and the microphones are arranged over several meters. Accordingly, the size of the device becomes large and it is not possible to easily carry the device.

On the contrary, the object sound extraction apparatus X1 to X3 are small devices that have about three to five microphones arranged at intervals of several centimeters and a very small processor such as a DSP or an ASIC for performing the signal processing (that is, the device is about a size of a common handy microphone, and can realize the sharp directivity illustrated in FIG. 12.

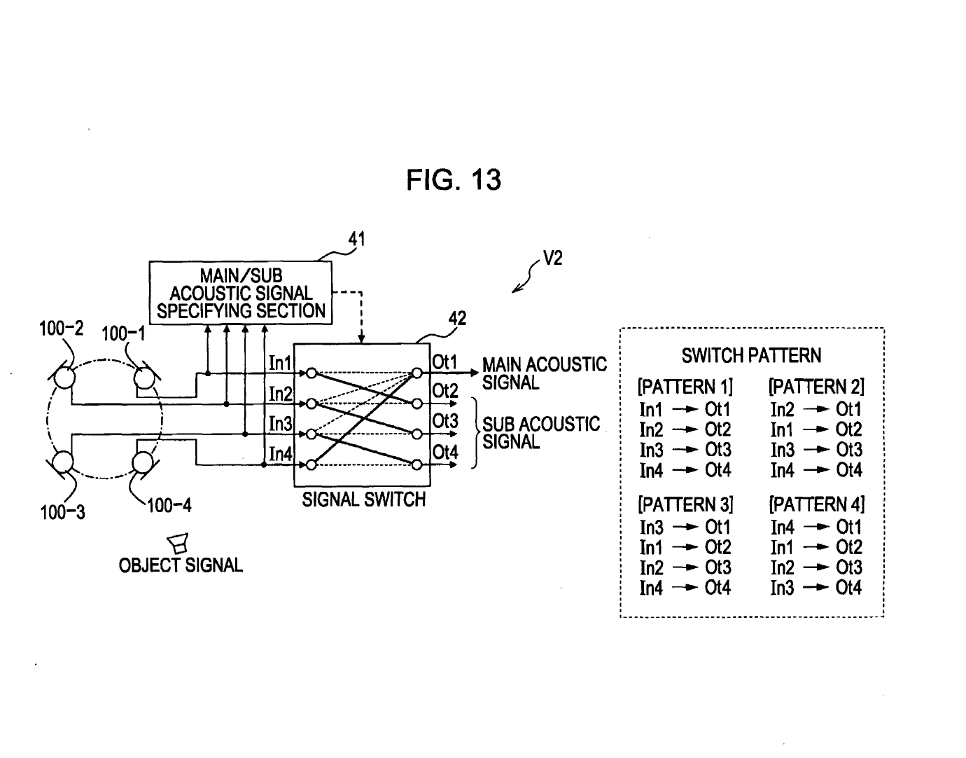

An acoustic input device V2 that is an example of devices that can be employed in the object sound extraction apparatus X1 to X3 in place of the acoustic input device V1 is described with reference to a block diagram in FIG. 13.

In the acoustic input device V1, the main microphone 101 for obtaining the main acoustic signal and the sub microphones 102 for obtaining the sub acoustic signals are assigned in advance. The acoustic input device V2 includes a plurality of microphones, and depending on environments, the use of the microphones as the main microphone 101 or the sub microphones 102 is switched.

As illustrated in FIG. 13, the acoustic input device V2 includes three or more (four in FIG. 13) microphones 100-1 to 100-4 and a main/sub acoustic signal specifying section 41, and a signal switcher 42.

The three or more microphones 100-1 to 100-4 are disposed at different positions or have different directive directions. The microphones 100-1 to 100-4 function as the main microphone 101 or the sub microphones 102 depending on environments.

For example, the microphones 100-1 to 100-4 have the same directivity, and as illustrated in FIG. 13, on a predetermined circumference (center PO) toward the outside in radial directions at equal intervals (such that central angles formed by connecting the positions of the microphones and the center PO of the circle respectively are equal to each other).

The main/sub acoustic signal specifying section 41, based on three or more inputted acoustic signals obtained via the three or more microphones 100-1 to 100-4 respectively, performs a processing to specify one main acoustic signal and a plurality of sun acoustic signals from the inputted acoustic signals (an example of the main/sub acoustic signal specifying means). Further, the main/sub acoustic signal specifying section 41 outputs a control signal corresponding to a specified result of the main acoustic signal and the sub acoustic signals to the signal switcher 42.

The main/sub acoustic signal specifying section 41, for example, compares signal strengths (acoustic pressures) of each of the three or more inputted acoustic signals. Then, the main/sub acoustic signal specifying section 41 specifies an inputted acoustic signal that has a maximum signal strength as the main acoustic signal, and specifies all of or a part of (two or more) the other inputted acoustic signals as the sub acoustic signals. As the method to specify a part of the other inputted acoustic signals as the sub acoustic signals, for example, it is possible to specify acoustic signals that can be obtained via the two microphones whose disposed positions or directional directions are adjacent to the both sides of the microphone to obtain the main acoustic signal, the microphones respectively.

Further, main/sub acoustic signal specifying section 41 can compare ratios of predetermined frequency components of each of the three or more inputted acoustic signals. Then, the main/sub acoustic signal specifying section 41 can specify an inputted acoustic signal that has a maximum ratio as the main acoustic signal, and specify all of or a part of (two or more) the other inputted acoustic signals as the sub acoustic signals. This method is effective in a case where the frequency characteristics of the acoustic generated by the object sound source are known at some level or the like.

The main/sub acoustic signal specifying section 41 is realized, for example, by a DSP, which is an example of a computer, and a ROM that stores a program implemented by a DSP, or an ASIC. In this case, the ROM stores a program for instructing the DSP to implement processing (described below) performed by the main/sub acoustic signal specifying section 41 in advance.

The signal switcher 42 switches transmission paths of the acoustic signals from the three or more microphones 100-1 to 100-4 to the sound source separation processing sections 10 based on the control signal (signal corresponding to the specified result of the signals) outputted from the main/sub acoustic signal specifying section 41 (an example of the signal path switching means).

The signal switcher 42 includes signal input ends In1 to In4 that are connected to the microphones 100-1 to 100-4 respectively. The signal switcher 42 further includes a signal output end Ot1 that outputs the main acoustic signal and a plurality of (three in FIG. 13) signal output ends Ot2 to Ot4 that output the sub acoustic signals. Further, the signal switcher 42 selectively switches signal paths for connecting each of the signal input ends In1 to In4 and the signal output ends Ot1 to Ot4 from a plurality of predetermined switching patterns. According to the operation, the acoustic signal specified by the main/sub acoustic signal specifying section 41 as the main acoustic signal is outputted from the output end Ot1, and the acoustic signals specified by the main/sub acoustic signal specifying section 41 as the sub acoustic signals are outputted from the output ends Ot2 to Ot4.

The object sound extraction apparatus X1 to X3 can be applied to a target for which a predetermined microphone in the microphones cannot be fixed because the position of the object sound source can vary by providing the acoustic input device V2 illustrated in FIG. 13.

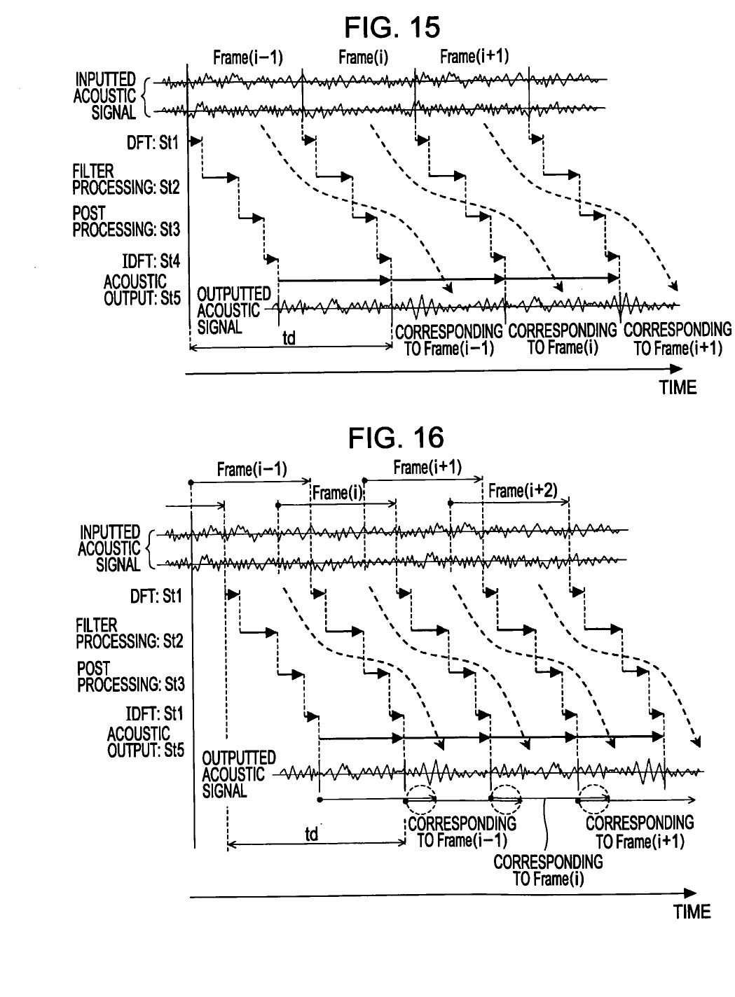

A sequence of a sound source separation processing in a case where the sound source separation processing sections 10 performs the sound source separation processing based on the FDICA method is described with reference to FIGS. 15 to 18. The sound source separation operation based on the FDICA is an example of sound source separation operations according to the Blind source separation method based on an independent component analysis. In the descriptions below, a post processing is a generic term used to refer to the processings performed by the object sound separation signal synthesis processing section 20 and the spectrum subtraction processing section 31 in the object sound extraction apparatus X1, the processing performed by the spectrum approximate signal extraction processing section 32 in the object sound extraction apparatus X2, and the processing performed by the spectrum subtraction processing section 31′ in the object sound extraction apparatus X3.

In the sound source separation processing based on the FDICA method, a processing to convert acoustic signals (hereinafter, referred to as inputted acoustic signals) time-sequentially inputted via a plurality of microphones (the main microphone 101 and the sub microphones 102 in the object sound extraction apparatus X1 to X3) into signals in the frequency domain, and a processing to perform a filter processing (matrix operation) based on a separation matrix W(f) are sequentially performed to generate a separation signals (the reference sound separation signal or the object sound separation signal). The inputted acoustic signals correspond to the mixed sound signals X₁(t) and X₂(t) in FIG. 14, and also correspond to the main acoustic signal and the sub acoustic signals in FIGS. 1, 3, and 5.

As described above, the filter processing is performed for every frame signal (for example, signal formed by diving the mixed sound signal into periods of several tens of milliseconds to several hundreds of milliseconds) of a predetermined time length. The calculation loads in the filter processing are small. Accordingly, if the filter processing is performed together with the post processing by a practical processor, the processing can be relatively easily performed in real time.

Further, as described above, in the sound source separation processing based on the FDICA method, using the inputted acoustic signals, a learning calculation (sequential calculation) for calculating the separation matrix W(f) used in the filter processing is also performed. The calculation loads in the learning calculation is large, and generally, the learning calculation is not suitable for real time processing.

FIG. 15 is a time chart illustrating a first example of a processing sequence performed in the object sound extraction apparatus X1 to X3 except for the learning calculation. Reference numerals St1, St2 . . . are identification signs in the processing procedure (steps).

As illustrated in FIG. 15, in the object sound extraction apparatus X1 to X3, the sound source separation processing sections 10 perform, with respect to the inputted acoustic signals, the DFT processing (St1) for each frame signal {Frame (i−1), Frame (i), Frame (i+1) . . . } of a predetermined time period, and instruct a memory to temporarily store frame signals in the frequency domain that is a result of the processing. In the first example, the sound source separation sections 10 perform the DFT processing (St1) in a period same as the time length of the frame signal. Accordingly, two successive frames do not have an overlapped period of time.

Further, the sound source separation sections 10 sequentially perform a filter processing (St2: matrix operation) based on the separation matrix W(f) for each frame signal in the frequency domain obtained by the DFT processing.

Further, the other processing sections (the object sound separation signal synthesis processing section 20 and the spectrum subtraction processing section 31, the spectrum approximate signal extraction processing section 32, or the spectrum subtraction processing section 31′) perform the post processing (St3) based on the separation signal obtained by the filter processing (St2). By the processings, the object sound extraction signals in the frequency domain corresponding to each of the frame signals in the inputted acoustic signals can be obtained.

Further, the IDFT processing section (not shown) performs an IDFT processing (St4) and converts the object sound extraction signals in the frequency domain into signals in the time domain. Then, the acoustic output processing section sequentially and externally outputs the object sound extraction signals (outputted acoustic signals) in the time domain (St5).

The calculation loads in the above-described steps St1 to St4 are small. Accordingly, if the processings are performed by a practical processor, the processings can be relatively easily completed within the period of the time length of the frame signal. Accordingly, though it takes some time delays (several tens of milliseconds to less than several hundreds of milliseconds) to the inputted acoustic signals, the outputted acoustic signals are outputted substantially in real time in response to the input of the inputted acoustic signals.

FIG. 16 is a time chart illustrating a second example of the processing sequence performed in the object sound extraction apparatus X1 to X3 except for the learning calculation.

Also in the example in FIG. 16, the sound source separation processing sections 10 perform, with respect to the inputted acoustic signals, the DFT processing (St1) for each frame signal {Frame (i−1), Frame (i), Frame (i+1) . . . }, and instruct the memory to temporarily store frame signals in the frequency domain that is the result of the processing. However, in the second example, the sound source separation sections 10 perform the DFT processing (St1) in a period shorter than the time length of the frame signal. Accordingly, two successive frames have an overlapped period of time.

Further, the sound source separation sections 10 sequentially perform the filter processing (St2: matrix operation) based on the separation matrix W(f) for each frame signal in the frequency domain obtained by the DFT processing and generate separation signals. In the processing, successive two frames of separation signals generated by the sound source separation sections 10 also have an overlapped period of time (the periods of time in the circles of wavy lines in FIG. 16). Accordingly, the sound source separation sections 10 perform a synthesis processing (weighted averaging processing, etc.) to the overlapped time period in the successive two frames of separation signals to generate a separation signal to be outputted.

Then, similarly to the first example (FIG. 15), the other processing sections perform the post processing (St3) based on the separation signal obtained by the filter processing (St2).

Further, similarly to the first example (FIG. 15), the IDFT processing section (not shown) performs the IDFT processing (St4) and converts the object sound extraction signals in the frequency domain into signals in the time domain. Then, the acoustic output processing section sequentially and externally outputs the object sound extraction signals (outputted acoustic signals) in the time domain (St5).

In the above-described processings in the second example, though it takes some time delays (several tens of milliseconds to less than several hundreds of milliseconds) to the inputted acoustic signals, the outputted acoustic signals are outputted substantially in real time in response to the input of the inputted acoustic signals.

Meanwhile, in the learning calculation in the sound source separation processing based on the FDICA method, in response to the input of the successive frame signals, a new separation matrix W(f) (separation matrix to be used in the filter processing subsequently performed) is calculated by a sequential calculation using the frame signals. The learning calculation is performed concurrently with the processings (St1 to St5) illustrated in FIG. 5. The new separation matrix W(f) calculated as described above is used in the filter processing that is subsequently performed.

Hereinafter, a set of a predetermined number of (a plurality of) the successive frame signals used in the learning calculation every time the new separation matrix W(f) is calculated is referred to as meta-frame signals. The meta-frame signals are signals (corresponding to block signals) divided into predetermined periods in time-sequentially inputted acoustic signals, and directly, the meta-frame signals that are converted (inverse discrete Fourier transformed) into signals in the frequency domain are used in the learning calculation. The time length (period of the signal block) of the frame signal is several tens of milliseconds to less than several hundreds of milliseconds. However, the time length (period of the signal block) of the meta-frame signal is time (for example, several seconds) allowed to adapt to change in acoustic environments though it depends on a performance of a processor that performs the processing.

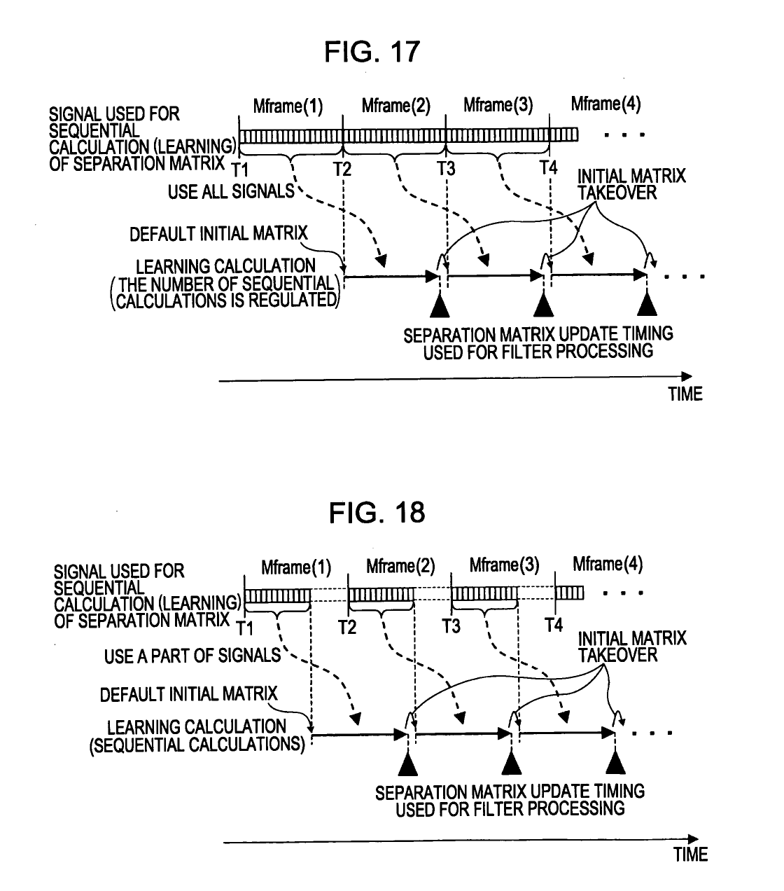

FIG. 17 is a time chart illustrating the learning calculation performed the sound source separation sections 10 that perform the sound source separation processing based on the FDICA method according to a first embodiment.

The example (the first embodiment) of the learning calculation (sequential calculation) illustrated in FIG. 17 is an example that the separation matrix W(f) to be used to the filter processing that is subsequently performed is calculated for each of meta-frame signals {Mframe (1), Mframe (2), Mframe (3) . . . } using all of the meta-frame signals. In this calculation, however, the number of the sequential calculations in the learning calculation is limited such that the number of the sequential calculations is a predetermined upper limit or less (if the number of the sequential calculations reaches to the upper limit, the sequential calculation is ended).

In the learning calculation according to the first embodiment illustrated in FIG. 17, using all of the meta-frames Mframe (1) corresponding to the inputted acoustic signal inputted in time Ti to Ti+1 (time Ti+1−Ti), the calculation (learning) of the separation matrix W(f) is performed. A separation matrix w(f) to be used in the filter processing that is subsequently performed is updated by a new separation matrix W(f) calculated by the learning calculation. In this processing, it is preferable to use a separation matrix W(f) calculated (learned) using a meta-frame signals Mframe(i) as an initial value (initial separation matrix) in calculating (sequentially calculating) a separation matrix W(f) using next meta-frame signals Mframe(i+1) to speed up convergence of the sequential calculation (learning).

Here, if the learning calculation having a large calculation load is performed without special limitation, time ts that is time necessary for the learning calculation in each meta-frame signal exceeds the time length (Ti+1−Ti). Then, it is difficult to quickly correspond to change in acoustic environments.

However, if the number of the sequential calculation in the learning calculation is limited to the upper limit such that the time ts that is time necessary for the learning calculation in each meta-frame signal is always shorter than the time length (Ti+1−Ti) of the meta-frame signal, it is possible to quickly correspond to the change in acoustic environments.

By the limitation (simplification of the learning calculation) of the number of the sequential calculations, if some noises are contained in the separation signals obtained by the sound source separation processing, by combining the sound source separation processing and the post processing (the spectrum subtraction processing or the spectrum approximate signal extraction processing), the object sound extraction performance can be sufficiently ensured as a whole.

In a first filter processing at a time starting (when a power of the device is turned on) of the processing in the object sound extraction apparatus X1 to X3, for example, a predetermined initial matrix, a separation matrix stored in the memory at a time ending (when the power of the device is turned off) a preceding processing, or the like can be used as the separation matrix.

The upper limitation is determined by a test or calculation in advance depending on the performance of the processor (DSP, ASIC, or the like) that implements the processing.

FIG. 18 is a time chart illustrating the learning calculation performed the sound source separation sections 10 that perform the sound source separation processing based on the FDICA method according to a second embodiment.

The example (the second embodiment) of the learning calculation (sequential calculation) illustrated in FIG. 18 is an example that the separation matrix W(f) to be used to the filter processing that is subsequently performed is calculated for each signal in a part of a time of a head side of the meta-frame signals {Mframe (1), Mframe (2), Mframe (3) . . . } using the signal in the part of the time.

In the learning calculation according to the second embodiment illustrated in FIG. 18, using the part of the time of the head side of the meta-frames Mframe (1) corresponding to the inputted acoustic signal inputted in the time T1 to Ti+1 (time Ti+1−Ti), the calculation (learning) of the separation matrix W(f) is performed. A separation matrix W(f) to be used in the filter processing that is subsequently performed is updated by a new separation matrix W(f) calculated by the learning calculation. In this processing, it is also preferable to use a separation matrix W(f) calculated (learned) using a meta-frame signals Mframe(i) as an initial value (initial separation matrix) in calculating (sequentially calculating) a separation matrix W(f) using a part of next meta-frame signals Mframe(i+1) to speed up convergence of the sequential calculation (learning).

In the second embodiment, by thinning a part of the meta-frame signals such that the time ts that is time necessary for the learning calculation in each meta-frame signal is always shorter than the time length (Ti+1−Ti) of the meta-frame signal, and using the thinned meta-frame signal, it is possible to quickly correspond to change in acoustic environments.

By the thinning of the signal used for the learning calculation (simplification of the learning calculation), if some noises are contained in the separation signals obtained by the sound source separation processing, by combining the sound source separation processing and the post processing (the spectrum subtraction processing or the spectrum approximate signal extraction processing), the object sound extraction performance can be sufficiently ensured as a whole.

The length of the time (the number of samples of digital signals) of the part used for the learning calculation in the meta-frame signal is determined by a test or calculation in advance depending on the performance of the processor (DSP, ASIC, or the like) that implements the processing.

The present invention can be applied to an object sound extraction apparatus that extracts an acoustic signal corresponding to an object sound from an acoustic signal containing object sound components and noise components, and outputs the extracted signal.

1. An object sound extraction apparatus comprising:
a main sound input section for mainly inputting an object sound generated by a predetermined object sound source and outputting a main acoustic signal;
sub voice input sections for mainly inputting one or more reference sounds generated by one or more sound sources other than the object sound source and outputting sub acoustic signals;
sound source separation sections for performing a sound source separation processing for separating and generating an object sound separation signal corresponding to the object sound and reference sound separation signals corresponding to the one or more reference sounds other than the object sound based on each combination of the main acoustic signal and the sub acoustic signals;
an object sound separation signal synthesis section for synthesizing the object sound separation signals and outputting a synthesis signal; and
a spectrum subtraction processing section for extracting an acoustic signal corresponding to the object sound from the synthesis signal by performing a spectrum subtraction processing between the synthesis signal and the reference sound separation signals, and outputting an extracted signal corresponding to the acoustic signal.

2. An object sound extraction apparatus comprising:
a main sound input section for mainly inputting an object sound generated by a predetermined object sound source and outputting a main acoustic signal;
sub voice input sections for mainly inputting one or more reference sounds generated by one or more sound sources other than the object sound source and outputting sub acoustic signals;
sound source separation sections for performing a sound source separation processing for separating and generating an object sound separation signal corresponding to the object sound based on each combination of the main acoustic signal and the sub acoustic signals; and
a spectrum approximate signal extraction section for extracting an acoustic signal corresponding to the object sound from the object sound extraction signals and outputting an extracted signal corresponding to the acoustic signal by dividing the object sound separation signals into signal components of each of a plurality of frequency bands, and extracting signal components that satisfy a predetermined approximation condition between the object sound separation signals.

3. An object sound extraction apparatus comprising:
a main sound input section for mainly inputting an object sound generated by a predetermined object sound source and outputting a main acoustic signal;
sub voice input sections for mainly inputting one or more reference sounds generated by one or more sound sources other than the object sound source and outputting sub acoustic signals;
sound source separation sections for performing a sound source separation processing for separating and generating a reference sound separation signal corresponding to the one or more reference sounds other than the object sound based on each combination of the main acoustic signal and the sub acoustic signals; and
a spectrum subtraction processing section for extracting an acoustic signal corresponding to the object sound from the main acoustic signal and outputting an extracted signal corresponding to the acoustic signal by performing a spectrum subtraction processing between the reference sound separation signals separated and generated by the main acoustic signal and the sound source separation sections.

4. The object sound extraction apparatus according to claim 1, wherein the sound source separation processing is a sound source separation processing according to a blind source separation method based on an independent component analysis.

5. The object sound extraction apparatus according to claim 1, wherein the sound source separation processing is a sound source separation processing according a binary masking processing.

6. The object sound extraction apparatus according to claim 4, wherein the sound source separation processing according to the blind source separation method based on the independent component analysis limits the number of the sequential calculations by, to the acoustic signals time-sequentially outputted by the main voice input section or the sub voice input sections (or, a voice input section), sequentially performing a filter processing based on a predetermined separation matrix to generate separation signals, and performing a sequential calculation for calculating the separation matrix that is to be used for the filter processing that is subsequently performed using all block signals for each block signal divided in a predetermined period in the acoustic signals.

7. The object sound extraction apparatus according to claim 4, wherein the sound source separation processing according to the blind source separation method based on the independent component analysis, to the acoustic signals time-sequentially outputted by the main voice input section or the sub voice input sections, sequentially performs a filter processing based on a predetermined separation matrix to generate separation signals, and performs a sequential calculation for calculating the separation matrix that is to be used for the filter processing that is subsequently performed using signals for each of the signals of a part of time at a head side of block signals divided in a predetermined period in the time-sequentially inputted acoustic signals.

8. The object sound extraction apparatus according to claim 1, wherein the sub voice input sections are disposed at positions different from a position of the main voice input section respectively.

9. The object sound extraction apparatus according to claim 1, wherein the sub voice input sections have directivities in directions different from a directivity of the main voice input section respectively.

10. The object sound extraction apparatus according to claim 1, further comprising:
a main/sub acoustic signal specification section for specifying the main acoustic signal and the sub acoustic signals from three or more acoustic signals outputted by the main voice input section and the sub voice input sections (or three or more voice input sections); and
a signal switching section for switching transmission paths of the acoustic signals from the three or more voice input sections to the sound source separation sections according to a result specified by the main/sub acoustic signal specification section.

11. The object sound extraction apparatus according to claim 10, wherein the main/sub acoustic signal specification section specifies the main acoustic signal and the sub acoustic signals by comparing signal strengths of each of the three or more acoustic signals.

12. The object sound extraction apparatus according to claim 7, wherein the main/sub acoustic signal specification section specifies the main acoustic signal and the sub acoustic signals by comparing ratios of predetermined frequency components in each of the three or more acoustic signals.

13. An object sound extraction method comprising:
a main sound input processing for mainly inputting an object sound generated by a predetermined object sound source and outputting a main acoustic signal;
a sub voice input processing for mainly inputting one or more reference sounds generated by one or more sound sources other than the object sound source and outputting sub acoustic signals;
a sound source separation processing for performing a sound source separation processing for separating and generating an object sound separation signal corresponding to the object sound and reference sound separation signals corresponding to the one or more reference sounds other than the object sound based on each combination of the main acoustic signal and the sub acoustic signals;
an object sound separation signal synthesis processing for synthesizing the object sound separation signals and outputting a synthesis signal; and
a spectrum subtraction processing for extracting an acoustic signal corresponding to the object sound from the synthesis signal by performing a spectrum subtraction processing between the synthesis signal and the reference sound separation signals, and outputting an extracted signal corresponding to the acoustic signal.

14. An object sound extraction method comprising:
a main sound input processing for mainly inputting an object sound generated by a predetermined object sound source and outputting a main acoustic signal;
a sub voice input processing for mainly inputting one or more reference sounds generated by one or more sound sources other than the object sound source and outputting sub acoustic signals;
a sound source separation processing for performing a sound source separation processing for separating and generating an object sound separation signal corresponding to the object sound based on each combination of the main acoustic signal and the sub acoustic signals; and
a spectrum approximate signal extraction processing for extracting an acoustic signal corresponding to the object sound from the object sound extraction signals and outputting an extracted signal corresponding to the acoustic signal by dividing the object sound separation signals into signal components of each of a plurality of frequency bands, and extracting signal components that satisfy a predetermined approximation condition between the object sound separation signals.

15. An object sound extraction method comprising:
a main sound input processing for mainly inputting an object sound generated by a predetermined object sound source and outputting a main acoustic signal;
a sub voice input processing for mainly inputting one or more reference sounds generated by one or more sound sources other than the object sound source and outputting sub acoustic signals;
a sound source separation processing for performing a sound source separation processing for separating and generating a reference sound separation signal corresponding to the one or more reference sounds other than the object sound based on each combination of the main acoustic signal and the sub acoustic signals; and
a spectrum subtraction processing for extracting an acoustic signal corresponding to the object sound from the main acoustic signal and outputting an extracted signal corresponding to the acoustic signal by performing a spectrum subtraction processing between the reference sound separation signals separated and generated by the main acoustic signal and the sound source separation processing.

16. The object sound extraction apparatus according to claim 2, wherein the sound source separation processing is a sound source separation processing according to a blind source separation method based on an independent component analysis.

17. The object sound extraction apparatus according to claim 3, wherein the sound source separation processing is a sound source separation processing according to a blind source separation method based on an independent component analysis.

18. The object sound extraction apparatus according to claim 2, wherein the sound source separation processing is a sound source separation processing according a binary masking processing.

19. The object sound extraction apparatus according to claim 3, wherein the sound source separation processing is a sound source separation processing according a binary masking processing.

20. The object sound extraction apparatus according to claim 16, wherein the sound source separation processing according to the blind source separation method based on the independent component analysis limits the number of the sequential calculations by, to the acoustic signals time-sequentially outputted by the main voice input section or the sub voice input sections (or, a voice input section), sequentially performing a filter processing based on a predetermined separation matrix to generate separation signals, and performing a sequential calculation for calculating the separation matrix that is to be used for the filter processing that is subsequently performed using all block signals for each block signal divided in a predetermined period in the acoustic signals.

21. The object sound extraction apparatus according to claim 17, wherein the sound source separation processing according to the blind source separation method based on the independent component analysis limits the number of the sequential calculations, by, to the acoustic signals time-sequentially outputted by the main voice input section or the sub voice input sections (or, a voice input section), sequentially performing a filter processing based on a predetermined separation matrix to generate separation signals, and performing a sequential calculation for calculating the separation matrix that is to be used for the filter processing that is subsequently performed using all block signals for each block signal divided in a predetermined period in the acoustic signals.

22. The object sound extraction apparatus according to claim 16, wherein the sound source separation processing according to the blind source separation method based on the independent component analysis, to the acoustic signals time-sequentially outputted by the main voice input section or the sub voice input sections, sequentially performs a filter processing based on a predetermined separation matrix to generate separation signals, and performs a sequential calculation for calculating the separation matrix that is to be used for the filter processing that is subsequently performed using signals for each of the signals of a part of time at a head side of block signals divided in a predetermined period in the time-sequentially inputted acoustic signals.

23. The object sound extraction apparatus according to claim 17, wherein the sound source separation processing according to the blind source separation method based on the independent component analysis, to the acoustic signals time-sequentially outputted by the main voice input section or the sub voice input sections, sequentially performs a filter processing based on a predetermined separation matrix to generate separation signals, and performs a sequential calculation for calculating the separation matrix that is to be used for the filter processing that is subsequently performed using signals for each of the signals of a part of time at a head side of block signals divided in a predetermined period in the time-sequentially inputted acoustic signals.

24. The object sound extraction apparatus according to claim 2, wherein the sub voice input sections are disposed at positions different from a position of the main voice input section respectively.

25. The object sound extraction apparatus according to claim 3, wherein the sub voice input sections are disposed at positions different from a position of the main voice input section respectively.

26. The object sound extraction apparatus according to claim 2, wherein the sub voice input sections have directivities in directions different from a directivity of the main voice input section respectively.

27. The object sound extraction apparatus according to claim 3, wherein the sub voice input sections have directivities in directions different from a directivity of the main voice input section respectively.

28. The object sound extraction apparatus according to claim 2, further comprising:
a main/sub acoustic signal specification section for specifying the main acoustic signal and the sub acoustic signals from three or more acoustic signals outputted by the main voice input section and the sub voice input sections (or three or more voice input sections); and
a signal switching section for switching transmission paths of the acoustic signals from the three or more voice input sections to the sound source separation sections according to a result specified by the main/sub acoustic signal specification section.

29. The object sound extraction apparatus according to claim 3, further comprising:
a main/sub acoustic signal specification section for specifying the main acoustic signal and the sub acoustic signals from three or more acoustic signals outputted by the main voice input section and the sub voice input sections (or three or more voice input sections); and
a signal switching section for switching transmission paths of the acoustic signals from the three or more voice input sections to the sound source separation sections according to a result specified by the main/sub acoustic signal specification section.

30. The object sound extraction apparatus according to claim 28, wherein the main/sub acoustic signal specification section specifies the main acoustic signal and the sub acoustic signals by comparing signal strengths of each of the three or more acoustic signals.

31. The object sound extraction apparatus according to claim 29, wherein the main/sub acoustic signal specification section specifies the main acoustic signal and the sub acoustic signals by comparing signal strengths of each of the three or more acoustic signals.

32. The object sound extraction apparatus according to claim 22, wherein the main/sub acoustic signal specification section specifies the main acoustic signal and the sub acoustic signals by comparing ratios of predetermined frequency components in each of the three or more acoustic signals.

33. The object sound extraction apparatus according to claim 23, wherein the main/sub acoustic signal specification section specifies the main acoustic signal and the sub acoustic signals by comparing ratios of predetermined frequency components in each of the three or more acoustic signals.
